(19) United States
(12) Patent Application Publication
(10) Pub. No.: US 2025/0290749 A1
(43) Pub. Date: Sep. 18, 2025

(54) SYSTEMS, DEVICES, AND METHODS FOR DOCUMENTING GROUND ASSETS AND ASSOCIATED UTILITY LINES

(71) Applicant: SeeScan, Inc., San Diego, CA (US)

(72) Inventor: Mark S. Olsson, La Jolla, CA (US)

(21) Appl. No.: 19/059,288

(22) Filed: Feb. 21, 2025

Related U.S. Application Data
(60) Provisional application No. 63/558,098, filed on Feb. 26, 2024.

(51) Int. Cl. G01C 15/10; G01C 3/06; G01C 19/38; G01S 17/89

(52) U.S. Cl. CPC G01C 15/10; G01C 3/06; G01C 19/38; G01S 17/89

(57) ABSTRACT

The present application relates to apparatuses, systems, and methods for mapping utility lines that includes the identification and use of ground assets. Such ground assets may be identifiable aspects along the ground surface that may be of interest or use, including mapping of utility locating. Further, updating to ground asset locations and yaw/orientations may be applied in maps such that utility line positions relative to such ground assets may be more accurately known by future excavation operations.

### CROSS-REFERENCE TO RELATED APPLICATIONS

This application claims priority under 35 U.S.C. § 119(e) to U.S. Provisional Patent Application Ser. No. 63/558,098, entitled SYSTEMS, DEVICES, AND METHODS FOR DOCUMENTING GROUND ASSETS AND ASSOCIATED UTILITY LINES, filed Feb. 26, 2024 the content of which is incorporated by reference herein in its entirety for all purposes.

### FIELD

This disclosure relates generally to systems, devices, and methods for documenting ground assets and associated utility lines. More specifically, but not exclusively, this disclosure relates to systems, apparatuses, and methods employing utility locator devices for automatically documenting ground assets and associated utility lines and refining mapped ground asset positions.

### BACKGROUND

Incidents resulting in damage to buried utility lines during excavation or other construction projects are frequently known to have catastrophic and costly consequences. For instance, incidental damage to utility lines has been known to result in damage to the surrounding buildings and infrastructure as well as injuries and even death to workers or others in the proximity of the incident. It is therefore imperative to the wellbeing and survival of nearby humans, buildings, and infrastructure to accurately determine the presence or absence of utility lines in the ground prior to beginning excavation or other construction projects. There are various technologies known in the art that attempt to avoid the horrific consequences associated with accidentally damaging buried utility lines.

Utility locator device and associated systems are a technology known in the art to locate buried utilities in an attempt avoid potential damage caused by striking a utility line during excavation. Such utility locator devices, also referred to as utility locators or simply locators, may include one or more antennas and associate receiver circuitry to sense magnetic signals to aid in determining if and where utility lines may be present below the ground surface as it is moved across a locating environment. Unfortunately, such utility locator devices and associated systems known in the art often fail to utilize data from other readily available sources that may aid in locating and mapping utility lines.

For instance, there are often indicators present on or at the ground level that may be associated with or otherwise aid in locating and mapping buried utility lines. Such objects and elements may be referred to in the art, as well as herein, as “ground assets” or simply “assets.” Most utility locator devices and associated systems fail, in any significant way, to take advantage of the data provided through examining ground assets and rely solely upon electromagnetic data. The few known utility locator devices and associated systems that document and utilize data available with ground assets rely upon a user's input to locate, identify, and tag or record those ground assets while simultaneously locating utility lines via measured electromagnetic signals. Such multi-tasking locating procedures may prove to be unduly burdensome for a user.

Accordingly, there is a need in the art to address the above-described as well as other problems related to utility locating and potholing operations and systems.

### SUMMARY

This disclosure relates generally to systems, devices, and methods for documenting ground assets and associated utility lines. More specifically, but not exclusively, this disclosure relates to systems, apparatuses, and methods employing utility locator devices for automatically documenting ground assets and associated utility lines and refining mapped ground asset positions.

In one aspect, the present invention relates to an asset tagging method for use in utility locating. The method including steps traversing a utility locating environment while determining EM Data that includes measurements of electromagnetic signals via an asset tagging utility locator device, generating images of the ground surface via an imaging element, generating Distance Data describing the distance between the utility locating device and one or more points on the ground surface in the images, and identifying Geolocation Data describing the geolocation of the utility locator device and Orientation Data describing the direction/heading, tilt, and pose of the utility locator device in three dimensions correlating with the Geolocation Data. In one step, the method includes determining, Locating Data describing the positions and depths of utility lines relative to the utility locator device from the EM data. In another step, the method includes mapping utility line geolocations via Geolocation Data and Orientation Data further included in the Locating Data. Further, the method includes a step identifying ground assets in the ground surface images. In another step, the method includes identifying the point or points in each image measured in the Distance Data by a rangefinder element. In another step, the method includes estimating the orientation of the image plane for each image in three dimensions. The method may further include a step orthorectifying each image based on the orientation of the image plane for each image in three dimensions. The method further includes a step locating and tracing, in each ground asset image, contrasting lines, arcs, colors, and other asset features. In another step, the method includes locating, in image tiles of a map of the locating environment, matching asset features in image tiles of a map of the utility locating environment and the images generated by the imaging element of the utility locator device. Further, the method including a step determining Offset Data describing the distance and direction between the mapped ground asset positions and the positions of matching ground assets in the images generated by the imaging element of the utility locator device. In another step, the method includes applying Offset Data in both degree and direction to mapped ground asset positions. In another step, the method includes generating a map with adjusted ground asset positions based on the Offset Data. In another step, the method includes merging mapped utility line locations on the updated map containing adjusted ground asset positions. Finally, the method includes a step for storing, in a memory element, Offset Data, ground asset images, maps with adjusted ground asset positions from the Offset Data, and maps including utility line positions and data to one or more system devices.

In another aspect the present invention includes asset tagging utility locator device for locating and mapping buried utility lines as well as associated ground assets on the ground surface. The asset tagging utility locator device of the present invention includes one or more antennas and associated receiver circuitry to determine EM Data measuring electromagnetic signals related to the positions of one or more buried utility lines relative to the utility locator device. Further, the asset tagging utility locator device of the present invention includes a positioning element having one or more apparatus to determine Geolocation Data describing the geolocation of the utility locator device and an orientation element including one or more sensors to determine Orientation Data describing the direction/heading, tilt, and pose of the utility locator device in three dimensions correlating with the Geolocation Data. The asset tagging utility locator device further including a rangefinder element to determine Distance Data describing the distance between the utility locating device and one or more points on the ground in the utility locating environment as the utility locator device is moved about the utility locating environment. An imaging element is included in the asset tagging utility locator device to generate images of the ground that includes the point(s) associated with the Distance Data while the utility locator device is moved about the utility locating environment. The asset tagging utility locator device of the present invention further includes a processing element having one or more processors to generate Locating Data describing the positions and depths of utility lines relative to the world from the EM Data, Geolocation Data, and Orientation Data; generate Ground Asset Data identifying and determining positions of ground assets from images of ground assets, Distance Data, Geolocation Data, and Orientation Data; identify matching ground assets in a map of the utility locating environment; determine Offset Data describing the difference in ground asset positions determined by the asset tagging utility locator device and the matching ground asset positions in the map in both distance and direction; and moving mapped ground asset positions based on Offset Data. The Locating Data, Ground Asset Data, Offset Data, utility maps, and other associated data may be stored in a memory element having one or more non-transitory memories. Finally, a power element for portioning of electrical power to the various powered elements is included in the asset tagging utility locator device of the present invention.

In another aspect, the present invention includes a computer implemented method for utility line positions and characteristics using Artificial Intelligence (AI) comprising. In one step, the method includes collecting Locating Data describing the positions and depths of utility lines in the ground from electromagnetic signals as well as other utility line characteristics via a utility locator device. In another step, the method includes collecting Ground Asset Data from ground surface images and digital maps of the utility locating environment. In another step, the method includes assembling a Training Database that includes Locating Data and Ground Asset Data. In another step, the method includes using deep learning to train a Neural Network (Artificial Intelligence/AI) via the Training Database Data. Predictions regarding the positions of utility lines and utility line characteristics may be generated in another step using AI. In another step, the method includes outputting predictions regarding the positions of utility lines and utility line characteristics.

Various additional aspects, features, and functionality are further described below in conjunction with the appended Drawings.

### BRIEF DESCRIPTION OF THE DRAWINGS

The present disclosure may be more fully appreciated in connection with the following detailed description taken in conjunction with the accompanying Drawings, wherein:

FIG. 1A is an illustration of a system including an asset tagging utility locator device of the present invention.

FIG. 1B is a diagram of the system from FIG. 1A.

FIG. 2 is a method for tagging ground assets.

FIG. 3 is an illustration of a user equipped with an asset tagging utility locator device traversing a utility locating environment while mapping ground assets and utility lines.

FIG. 4A is an illustration of an asset tagging utility locator device determining position of a ground point on an identified ground asset.

FIG. 4B is an illustration of the asset tagging utility locator device demonstrating heading information that may be used in yaw corrections.

FIG. 5A is an illustration of an exemplary ground asset identifying ground asset features.

FIG. 5B is an illustration of an exemplary ground asset identifying ground asset features.

FIG. 5C is another illustration of an exemplary ground asset identifying ground asset features.

FIG. 6 is another illustration of matching images of ground asset to a map that includes ground assets.

FIG. 7 is an illustration demonstrating determining translation and yaw/orientation corrections for the ground asset of FIG. 5A from the calculated Offset Data.

FIG. 8 is an illustration applying translation and yaw/orientation corrections from FIG. 7 on a map that further includes mapped utility lines and associated utility data.

FIG. 9 is a method of providing Training Data the includes Locating Data and Ground Asset Data to a Neural Network to use Deep Learning/artificial intelligence to recognize patterns and make predictions related to underground utilities.

FIG. 10A is a diagram of example sources of Locating Data that may be used to train Neural Networks.

FIG. 10B is a diagram of example sources of Ground Asset Data that may be used to train Neural Networks

### DETAILED DESCRIPTION OF EMBODIMENTS

### Overview

This disclosure relates generally to systems, devices, and methods for documenting ground assets and associated utility lines. More specifically, but not exclusively, this disclosure relates to systems, apparatuses, and methods employing utility locator devices for automatically documenting ground assets and associated utility lines and refining mapped ground asset positions.

In one aspect, the present invention relates to an asset tagging method for use in utility locating. This method may be performed in real-time, near real-time, or in post processing. The method including steps traversing a utility locating environment while determining EM Data that includes measurements of electromagnetic signals via an asset tagging utility locator device, generating images of the ground surface via an imaging element, generating Distance Data describing the distance between the utility locating device and one or more points on the ground surface in the images, and identifying Geolocation Data describing the geolocation of the utility locator device and Orientation Data describing the direction/heading, tilt, and pose of the utility locator device in three dimensions correlating with the Geolocation Data. Optionally, the method may include a step to receive input from a user (e.g., notation of the presence and/or descriptions of ground assets, notate related information, information regarding association with buried utility lines, and the like) via an input apparatus (e.g., a microphone, keyboard, or like apparatus to input information). In one step, the method includes determining, from EM data, Locating Data describing the positions and depths of utility lines relative to the utility locator device. In another step, the method includes mapping utility line geolocations via Geolocation Data and Orientation Data further included in the Locating Data. Further, the method includes a step identifying ground assets in the ground surface images. In another step, the method includes identifying the point or points in each image measured in the Distance Data by a rangefinder element. In another step, the method includes estimating the orientation of the plane for each image in three dimensions. The method may further include a step orthorectifying each image based on the orientation of the plane for each image in three dimensions. The method further includes a step locating and tracing, in each ground asset image, contrasting lines, arcs, colors, and other asset features. In another step, the method includes locating, in image tiles of a map of the locating environment, matching asset features in image tiles of a map of the utility locating environment and the images generated by the imaging element of the utility locator device. Further, the method including a step determining Offset Data describing the distance and direction between the mapped ground asset positions and the matching positions of ground assets in the images generated by the imaging element of the utility locator device. The Offset Data may include yaw orientation corrections for the ground asset. In another step, the method includes applying Offset Data in both degree and direction to the map tiles containing the ground asset. This step may include yaw orientation corrections. In another step, the method includes generating a map with adjusted ground asset positions based on the Offset Data. In another step, the method includes merging mapped utility line locations on the updated map containing adjusted ground asset positions. Such a map may further include utility line depths and other information regarding the utility lines. Further, the method includes steps storing, in a memory element, Offset Data, ground asset images, maps with adjusted ground asset positions from the Offset Data, and maps including utility line positions and data to one or more system devices. Optionally, the method may include displaying the map with adjusted ground asset positions from the Offset Data. In some embodiments, the method may include a step communicating the Offset data, ground asset images, and map with adjusted ground asset positions from the Offset Data to one or more system devices for display and storage. In an optional step, ground asset positions may be continually updated on the map based on estimated crustal plate motion or velocity.

In another aspect the present invention includes asset tagging utility locator device for locating and mapping buried utility lines as well as associated ground assets on the ground surface. The asset tagging utility locator device of the present invention includes one or more antennas and associated receiver circuitry to determine EM Data measuring electromagnetic signals related to the positions of one or more buried utility lines relative to the utility locator device. Further, the asset tagging utility locator device of the present invention includes a positioning element having one or more apparatus to determine Geolocation Data describing the geolocation of the utility locator device and an orientation element including one or more sensors to determine Orientation Data describing the direction/heading, tilt, and pose of the utility locator device in three dimensions correlating with the Geolocation Data. The Geolocation Data and/or Orientation Data and/or images of the ground surface and ground assets may, in some embodiments, be generated via a smartphone coupled with the utility locator device. The Geolocation Data may include, for instance, be or include global navigation satellite system (GNSS). The GNSS (e.g., GPS, GLONASS, BeiDou, Quasi-Zenith Satellite Systems, Galileo, and the like) that may further include precise point positioning real time kinematics (PPP-RTK), state space representation (SSR), and/or other like corrections as well as other such systems for determining a position in the world frame. The orientation element may be or include one or more accelerometers, magnetometers, gyroscopic sensors, altimeters, and other inertial navigation systems (INS).

The asset tagging utility locator device further including a rangefinder element to determine Distance Data describing the distance between the utility locating device and one or more points on the ground in the utility locating environment as the utility locator device is moved about the utility locating environment. The rangefinder element may be or include a laser rangefinder which may be a multi-spectral laser rangefinder. An imaging element is included in the asset tagging utility locator device to generate images of the ground that includes the point(s) associated with the Distance Data while the utility locator device is moved about the utility locating environment. The imaging element may be or include light detection and ranging (LiDAR). The asset tagging utility locator device of the present invention further includes a processing element having one or more processors to generate Locating Data describing the positions and depths of utility lines relative to the world from the EM Data, Geolocation Data, and Orientation Data; generate Ground Asset Data identifying and determining positions of ground assets from images of ground assets, Distance Data, Geolocation Data, and Orientation Data; identify matching ground assets in a map of the utility locating environment; determine Offset Data describing the difference in ground asset positions determined by the asset tagging utility locator device and matching ground asset positions in the map in both distance and direction; and moving mapped ground asset positions based on Offset Data. The Offset Data may include yaw corrections determined through differences in orientation between mapped ground assets and matching ground assets in images generated via the asset tagging utility locator device. The Locating Data, Ground Asset Data, Offset Data, utility maps, and other associated data may be stored in a memory element having one or more non-transitory memories. The memory element may be disposed in the asset tagging utility locator device. In some embodiments, the memory element may additionally or instead be disposed in a utility locating system device (e.g., a smartphone, cloud server or other remote database, or the like). Finally, a power element for portioning of electrical power to the various powered elements is included in the asset tagging utility locator device.

In some embodiments, an asset tagging utility locator device may include one or more input apparatus. For instance, an input apparatus may be or include a microphone, keyboard, or like apparatus allowing a user to input information.

In some embodiments, an asset tagging utility locator device may include a display device. The display device may display utility line and ground asset positions as well as other utility locating information.

In another aspect, the present invention includes a computer implemented method for utility line positions and characteristics using Artificial Intelligence (AI) comprising. In one step, the method includes collecting Locating Data describing the positions and depths of utility lines in the ground from electromagnetic signals via a utility locator device. The Locating Data may include but should not be limited to utility line positions, utility line depths, maps of the utility locating environment including utility line positions and depths, and/or identification information regarding utility line types. Likewise, the Locating Data may include EM Data, position and depth estimates of utility lines, Geolocation Data, Orientation Data, User Input Data, and other data related to the location/position and characteristics of utility lines. In another step, the method includes collecting Ground Asset Data from ground surface images and digital maps of the utility locating environment. The Ground Asset Data may include but should not be limited to images of one or more ground assets, geolocations of ground assets, and/or dimensions of ground assets, identification information regarding ground assets. Further, the Ground Asset Data may include Distance Data, orthorectification data of images, User Input Data, data associating ground assets with utility lines, Geolocation Data relating to ground assets, Offset Data, data relating to matching ground assets in images and map data, and/or other data related to ground assets. In another step, the method includes assembling a Training Database that includes Locating Data and Ground Asset Data. The Training Database may further include includes one or more maps of the utility locating environment, user input data, and/or other data. In another step, the method includes using deep learning to train a Neural Network (Artificial Intelligence/AI) via the Training Database Data. Predictions regarding the positions of utility lines and utility line characteristics may be generated in another step using AI. In some embodiments, the AI may generate predictions regarding mapping positions of utility lines, the association between ground assets and buried utility lines, and/or other predictions regarding utility lines. In another step, the method includes outputting predictions regarding the positions of utility lines and utility line characteristics. The step may include generating predictions regarding the association between ground assets and buried utility lines. Even further, the step may include generating predictions regarding mapping utility lines.

The disclosure herein may be may be used in or combined with the devices and methods described herein, are disclosed in co-assigned patents and patent applications including: U.S. Pat. No. 5,939,679, issued Aug. 17, 1999, entitled VIDEO PUSH CABLE; U.S. Pat. No. 6,545,704, issued Apr. 8, 1999, entitled VIDEO PIPE INSPECTION DISTANCE MEASURING SYSTEM; U.S. Pat. No. 6,831,679, issued Dec. 14, 2004, entitled VIDEO CAMERA HEAD WITH THERMAL FEEDBACK LIGHTING CONTROL; U.S. Pat. No. 6,862,945, issued Mar. 8, 2005, entitled CAMERA GUIDE FOR VIDEO PIPE INSPECTION SYSTEM; U.S. Pat. No. 6,958,767, issued Oct. 25, 2005, entitled VIDEO PIPE INSPECTION SYSTEM EMPLOYING NON-ROTATING CABLE STORAGE DRUM; U.S. patent application Ser. No. 12/704,808, filed Feb. 13, 2009, entitled PIPE INSPECTION SYSTEM WITH REPLACEABLE CABLE STORAGE DRUM; U.S. patent application Ser. No. 13/647,310, filed Feb. 13, 2009, entitled PIPE INSPECTION SYSTEM APPARATUS AND METHOD; U.S. patent application Ser. No. 13/346,668, filed Jan. 9, 2012, entitled PORTABLE CAMERA CONTROLLER PLATFORM FOR USE WITH PIPE INSPECTION SYSTEM; U.S. patent application Ser. No. 14/749,545, filed Jan. 30, 2012, entitled ADJUSTABLE VARIABLE RESOLUTION INSPECTION SYSTEMS AND METHODS; U.S. Pat. No. 8,289,385, issued Oct. 16, 2012, entitled PUSH-CABLE FOR PIPE INSPECTION SYSTEM; U.S. Pat. No. 8,395,661, issued Mar. 12, 2013, entitled PIPE INSPECTION SYSTEM WITH SELECTIVE IMAGE CAPTURE; U.S. patent application Ser. No. 13/826,112, filed Mar. 14, 2013, entitled SYSTEMS AND METHODS INVOLVING A SMART CABLE STORAGE DRUM AND NETWORK NODE FOR TRANSMISSION OF DATA; U.S. patent application Ser. No. 14/033,349, filed Sep. 20, 2013, entitled PIPE INSPECTION SYSTEM WITH SNAP-ON PIPE GUIDES; U.S. Pat. No. 8,540,429, issued Sep. 24, 2013, entitled SNAP ON PIPE GUIDE; U.S. Pat. No. 8,587,648, issued Nov. 19, 2013, entitled SELF-LEVELING CAMERA HEAD; U.S. patent application Ser. No. 14/136,104, filed Dec. 20, 2013, entitled ROTATING CONTACT ASSEMBLIES FOR SELF-LEVELING CAMERA HEADS; U.S. patent application Ser. No. 14/203,485, filed Mar. 10, 2014, entitled PIPE INSPECTION CABLE COUNTER AND OVERLAY MANAGEMENT SYSTEM; U.S. patent application Ser. No. 14/207,527, filed Mar. 12, 2014, entitled ROTATING CONTACT ASSEMBLIES FOR SELF-LEVELING CAMERA HEADS; U.S. patent application Ser. No. 14/216,358, filed Mar. 17, 2014, entitled SMART CABLE STORAGE DRUM AND NETWORK NODE SYSTEM AND METHODS; U.S. patent application Ser. No. 14/557,163, filed Dec. 1, 2014, entitled ASYMMETRIC DRAG FORCE BEARINGS; U.S. Pat. No. 8,908,027, issued Dec. 9, 2014, entitled ASYMMETRIC DRAG FORCE BEARING FOR USE WITH PUSH-CABLE STORAGE DRUM; U.S. Pat. No. 8,970,211, issued Mar. 3, 2015, entitled PIPE INSPECTION CABLE COUNTER AND OVERLAY MANAGEMENT SYSTEM; U.S. patent application Ser. No. 14/642,596, filed Mar. 9, 2015, entitled PIPE CLEARING CABLES AND APPARATUS; U.S. Pat. No. 8,984,698, issued Mar. 24, 2015, entitled LIGHT WEIGHT SEWER CABLE; U.S. patent application Ser. No. 14/746,590, filed Jun. 22, 2015, entitled THERMAL EXTRACTION ARCHITECTURES FOR CAMERA AND LIGHTING DEVICES; U.S. Pat. No. 9,066,446, issued Jun. 23, 2015, entitled THERMAL EXTRACTION ARCHITECTURE FOR CAMERA HEADS, INSPECTION SYSTEMS, AND OTHER DEVICES AND SYSTEMS; U.S. Pat. No. 9,080,992, issued Jul. 14, 2015, entitled ADJUSTABLE VARIABLE RESOLUTION INSPECTION SYSTEMS AND METHODS; U.S. Pat. No. 9,134,255, issued Sep. 15, 2015, entitled PIPE INSPECTION SYSTEM WITH SELECTIVE CAPTURE; U.S. patent application Ser. No. 14/935,878, filed Nov. 9, 2015, entitled INSPECTION CAMERA DEVICES AND METHODS WITH SELECTIVELY ILLUMINATED MULTISENSOR IMAGING; U.S. patent application Ser. No. 14/970,362, filed Dec. 15, 2014, entitled COAXIAL VIDEO PUSH-CABLES FOR USE IN INSPECTION SYSTEMS; U.S. Pat. No. 9,222,809, issued Dec. 29, 2015, entitled PORTABLE PIPE INSPECTION SYSTEMS AND APPARATUS; U.S. patent application Ser. No. 15/050,267, filed Feb. 22, 2016, entitled SELF-LEVELING CAMERA HEADS; U.S. Pat. No. 9,277,105, issued Mar. 1, 2016, entitled SELF-LEVELING CAMERA HEADS; U.S. patent application Ser. No. 15/264,355, filed Sep. 13, 2016, entitled HIGH BANDWIDTH VIDEO PUSH-CABLES FOR PIPE INSPECTION SYSTEMS; U.S. Pat. No. 9,448,376, issued Sep. 20, 2016, entitled HIGH BANDWIDTH PUSH-CABLES FOR VIDEO PIPE INSPECTION SYSTEMS; U.S. Pat. No. 9,468,954, issued Oct. 18, 2016, entitled PIPE INSPECTION SYSTEM WITH JETTER PUSH-CABLE; U.S. Pat. No. 9,477,147, issued Oct. 25, 2016, entitled SPRING ASSEMBLIES WITH VARIABLE FLEXIBILITY FOR USE WITH PUSH-CABLES AND PIPE INSPECTION SYSTEMS; U.S. patent application Ser. No. 15/369,693, filed Dec. 5, 2016, entitled CABLE STORAGE DRUM WITH MOVEABLE CCU DOCKING APPARATUS; U.S. Pat. No. 9,521,303, issued Dec. 13, 2016, entitled CABLE STORAGE DRUM MOVABLE CCU DOCKING APPARATUS; U.S. patent application Ser. No. 15/425,785, filed Feb. 6, 2017, entitled METHOD AND APPARATUS FOR HIGH-SPEED DATA TRANSFER EMPLOYING SELF-SYNCHRONIZING QUADRATURE AMPLITUDE MODULATION; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION; U.S. patent application Ser. No. 15/483,924, filed Apr. 10, 2017, entitled SYSTEMS AND METHODS FOR DATA TRANSFER USING SELF-SYNCHRONIZING QUADRATURE AMPLITUDE MODULATION; U.S. Pat. No. 9,625,602, issued Apr. 18, 2017, entitled SMART PERSONAL COMMUNICATION DEVICES AS USER INTERFACES; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION; U.S. patent application Ser. No. 15/590,964, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. patent application Ser. No. 15/670,845, filed Aug. 7, 2017, entitled HIGH FREQUENCY AC-POWERED DRAIN CLEANING AND INSPECTION APPARATUS AND METHODS; U.S. patent application Ser. No. 15/701,247, filed Sep. 11, 2017, entitled PIPE INSPECTION SYSTEMS WITH SELF-GROUNDING PORTABLE CAMERA CONTROLLERS; U.S. Pat. No. 9,769,366, issued Sep. 19, 2017, entitled ELF-GROUNDING TRANSMITTING PORTABLE CAMERA CONTROLLER FOR USE WITH PIPE INSPECTION SYSTEMS; U.S. Pat. No. 9,791,382, issued Oct. 17, 2017, entitled PIPE INSPECTION SYSTEM WITH JETTER PUSH-CABLE; U.S. patent application Ser. No. 15/728,410, filed Oct. 9, 2017, entitled PIPE INSPECTION SYSTEM WITH JETTER PUSH-CABLE; U.S. patent application Ser. No. 15/805,007, filed Nov. 6, 2017, entitled PIPE INSPECTION SYSTEM CAMERA HEADS; U.S. patent application Ser. No. 15/806,219, filed Nov. 7, 2017, entitled MULTI-CAMERA PIPE INSPECTION APPARATUS, SYSTEMS AND METHODS; U.S. patent application Ser. No. 15/811,264, filed Nov. 13, 2017, entitled SPRING ASSEMBLIES WITH VARIABLE FLEXIBILITY FOR USE WITH PUSH-CABLES AND PIPE INSPECTION SYSTEMS; U.S. Pat. No. 9,824,433, issued Nov. 21, 2017, entitled PIPE INSPECTION SYSTEM CAMERA HEADS; U.S. Pat. No. 9,829,783, issued Nov. 28, 2017, entitled SPRING ASSEMBLIES WITH VARIABLE FLEXIBILITY FOR USE WITH PUSH-CABLES AND PIPE INSPECTION SYSTEMS; U.S. Pat. No. 9,835,564, issued Dec. 5, 2017, entitled MULTI-CAMERA PIPE INSPECTION APPARATUS, SYSTEMS, AND METHODS; U.S. patent application Ser. No. 15/919,077, filed Mar. 27, 2018, entitled PORTABLE PIPE INSPECTION SYSTEMS AND METHODS; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 15/922,703, filed Mar. 15, 2018, entitled SELF-LEVELING INSPECTION SYSTEMS AND METHODS; U.S. Pat. No. 9,924,139, issued Mar. 20, 2018, entitled PORTABLE PIPE INSPECTION SYSTEMS AND APPARATUS; U.S. Pat. No. 9,927,368, issued Mar. 27, 2018, entitled SELF-LEVELING INSPECTION SYSTEMS AND METHODS; U.S. Provisional Patent Application 62/686,589, filed Jun. 18, 2018, entitled MULTI-DIELECTRIC COAXIAL PUSH-CABLES; U.S. Provisional Patent Application 62/726,500, filed Sep. 4, 2018, entitled VIDEO PIPE INSPECTION SYSTEMS, DEVICES, AND METHODS INTEGRATED WITH NON-VIDEO DATA RECORDING AND COMMUNICATION FUNCTIONALITY; U.S. Provisional Patent Application 62/756,538, filed Nov. 6, 2018, entitled ROBUST AND LOW COST IMPEDANCE CONTROLLED SLIP RINGS; U.S. Provisional Patent Application 62/768,760, filed Nov. 16, 2018, entitled PIPE INSPECTION AND/OR MAPPING CAMERA HEADS, SYSTEMS, AND METHODS; U.S. Provisional Patent Application 62/794,863, filed Jan. 21, 2019, entitled HEAT EXTRACTION ARCHITECTURE FOR COMPACT VIDEO HEADS; U.S. patent application Ser. No. 16/443,789, filed Jun. 17, 2019, entitled MULTI-DIELECTRIC COAXIAL PUSH-CABLES AND ASSOCIATED APPARATUS; U.S. Pat. No. 10,356,360, issued Jul. 16, 2019, entitled HIGH BANDWIDTH VIDEO PUSH-CABLE FOR PIPE INSPECTION SYSTEMS; U.S. Pat. No. 10,359,368, issued Jul. 23, 2019, entitled PIPE INSPECTION SYSTEM WITH JETTER PUSH-CABLE; U.S. Pat. No. 10,379,436, issued Aug. 13, 2019, entitled SPRING ASSEMBLIES WITH VARIABLE FLEXIBILITY FOR USE WITH PUSH-CABLES AND PIPE INSPECTION SYSTEMS; U.S. Pat. No. 10,440,332, issued Oct. 8, 2019, entitled INSPECTION CAMERA DEVICES AND METHODS WITH SELECTIVELY ILLUMINATED MULTISENSOR IMAGINING; U.S. Pat. No. 10,527,402, issued Jan. 7, 2020, entitled PIPE INSPECTION SYSTEM CABLE COUNTER AND OVERLAY MANAGEMENT SYSTEM; U.S. Pat. No. 10,585,012, issued Mar. 10, 2020, entitled PORTABLE CAMERA CONTROLLER FOR USE WITH PIPE INSPECTION SYSTEMS; U.S. Pat. No. 10,613,034, issued Apr. 7, 2020, entitled SELF-LEVELING INSPECTION SYSTEMS AND METHODS; U.S. Pat. No. 10,715,703, issued Jul. 14, 2020, entitled SELF-LEVELING CAMERA HEADS; U.S. Pat. No. 10,761,233, issued Sep. 1, 2020, entitled SONDES AND METHODS FOR USE WITH BURIED LINE LOCATOR SYSTEMS; U.S. Pat. No. 10,764,541, issued Sep. 1, 2020, entitled COAXIAL VIDEO PUSH-CABLES FOR USE IN INSPECTION SYSTEMS; U.S. patent application Ser. No. 17/087,554, filed Nov. 2, 2020, entitled PORTABLE PIPE INSPECTION SYSTEMS AND METHODS; U.S. Pat. No. 10,834,364, issued Nov. 10, 2020, entitled PORTABLE PIPE INSPECTION SYSTEMS AND METHODS; U.S. Pat. No. 10,841,144, issued Nov. 17, 2020, entitled SYSTEM AND METHODS FOR DATA TRANSFER USING SELF-SYNCHRONIZING QUADRATURE AMPLITUDE MODULATION (QAM); U.S. Pat. No. 10,855,950, issued Dec. 1, 2020, entitled HIGH BANDWIDTH VIDEO PUSH-CABLES FOR PIPE INSPECTION SYSTEMS; U.S. Pat. No. 10,863,064, issued Dec. 8, 2020, entitled CABLE STORAGE DRUM WITH MOVEABLE CCU DOCKING APPARATUS; U.S. Pat. No. 10,907,690, issued Feb. 2, 2021, entitled PIPE INSPECTION SYSTEMS WITH ASSYMETRIC DRAG FORCE BEARINGS; U.S. Pat. No. 10,921,263, issued Feb. 16, 2021, entitled PIPE INSPECTION SYSTEM WITH JETTER PUSH-CABLE; U.S. patent application Ser. No. 17/182,113, filed Feb. 22, 2021, entitled VIDEO PIPE INSPECTION SYSTEMS; U.S. patent application Ser. No. 17/202,128, filed Mar. 15, 2021, entitled BORING INSPECTION SYSTEMS AND METHODS; U.S. Pat. No. 10,955,583, issued Mar. 23, 2021, entitled BORING INSPECTION SYSTEMS AND METHODS; U.S. Pat. No. 10,976,462, issued Apr. 13, 2021, entitled VIDEO INSPECTION SYSTEMS WITH PERSONAL COMMUNICATION DEVICE USER INTERFACES; U.S. Pat. No. 10,992,849, issued Apr. 27, 2021, entitled PIPE INSPECTION SYSTEMS WITH SELF-GROUNDING PORTABLE CAMERA CONTROLLERS; U.S. Pat. No. 11,016,381, issued May 25, 2021, entitled SPRING ASSEMBLIES WITH VARIABLE FLEXIBLE FOR USE WITH PUSH-CABLES AND PIPE INSPECTION SYSTEMS; U.S. patent application Ser. No. 17/397,940, filed Aug. 9, 2021, entitled INSPECTION SYSTEM PUSH-CABLE GUIDE APPARATUS; U.S. Pat. No. 11,088,890, issued Aug. 10, 2021, entitled VIDEO INSPECTION SYSTEMS AND METHODS USING SELF-SYNCHRONIZING QAM; U.S. Pat. No. 11,132,781, issued Sep. 28, 2021, entitled PIPE INSPECTION SYSTEM CAMERA HEADS; U.S. patent application Ser. No. 17/528,155, filed Nov. 16, 2021, entitled PORTABLE CAMERA CONTROLLER PLATFORM FPR USE WITH PIPE INSPECTION SYSTEMS; U.S. Pat. No. 11,178,317, issued Nov. 16, 2021, entitled HEAT EXTRACTION APPARATUS; U.S. patent application Ser. No. 17/528,956, filed Nov. 17, 2021, entitled VIDEO INSPECTION SYSTEM APPARATUS AND METHODS WITH RELAY MODULES AND CONNECTION PORTS; U.S. patent application Ser. No. 17/531,533, filed Nov. 19, 2021, entitled INPUT MULTIPLEXED SIGNAL PROCESSING APPARATUS AND METHODS; U.S. patent application Ser. No. 17/532,938, filed Nov. 22, 2021, entitled PIPE INSPECTION AND/OR MAPPING CAMERA HEADS, SYSTEMS, AND METHODS; U.S. Pat. No. 11,187,822, issued Nov. 30, 2021, entitled SONDE DEVICES INCLUDING SECTIONAL FERRITE CORE STRUCTURE; U.S. Pat. No. 11,187,971, issued Nov. 30, 2021, entitled ROTATING CONTACT ASSEMBLIES FOR SELF-LEVELING CAMERA HEADS; U.S. Pat. No. 11,199,510, issued Dec. 14, 2021, entitled PIPE INSPECTION AND CLEANING APPARATUS AND SYSTEMS; U.S. Pat. No. 11,209,115, issued Dec. 28, 2021, entitled PIPE INSPECTION AND/OR MAPPING CAMERA HEADS, SYSTEMS, AND METHODS; U.S. Pat. No. 11,209,334, issued Dec. 28, 2021, entitled PORTABLE CAMERA CONTROLLER PLATFORM FOR USE WITH PIPE INSPECTION SYSTEMS; U.S. Pat. No. 11,300,700, issued Apr. 12, 2022, entitled SYSTEM AND METHODS OF USING A SONDE DEVICE WITH A SECTIONAL FERRITE CORE STRUCTURE; U.S. patent application Ser. No. 17/868,709, filed Jul. 19, 2022, entitled INSPECTION CAMERA DEVICES AND METHODS; U.S. patent application Ser. No. 17/815,387, filed Jul. 27, 2022, entitled INWARD SLOPED DRUM FACE FOR PIPE INSPECTION CAMERA SYSTEM; U.S. Pat. No. 11,402,337, issued Aug. 2, 2022, entitled VIDEO PIPE INSPECTION SYSTEMS WITH VIDEO INTEGRATED WITH ADDITIONAL SENSOR DATA; U.S. Pat. No. 11,418,761, issued Aug. 16, 2022, entitled INSPECTION CAMERA DEVICES AND METHODS WITH SELECTIVELY ILLUMINATED MULTISENSOR IMAGING; U.S. Pat. No. 11,448,600, issued Sep. 20, 2022, entitled MULTI-CAMERA PIPE INSPECTION APPARATUS, SYSTEMS, AND METHODS; U.S. patent application Ser. No. 17/993,784, filed Nov. 23, 2022, entitled VIDEO PIPE INSPECTION SYSTEMS; U.S. Pat. No. 11,528,401, issued Dec. 13, 2022, entitled PIPE INSPECTION SYSTEMS WITH SELF-GROUNDING PORTABLE CAMERA CONTROLLERS; U.S. patent application Ser. No. 18/091,079, filed Dec. 29, 2022, entitled VIDEO INSPECTION SYSTEMS WITH WIRELESS ENABLED DRUM; U.S. patent application Ser. No. 18/148,850, filed Dec. 30, 2022, entitled SPRING ASSEMBLIES WITH VARIABLE FLEXIBILITY FOR USE WITH PUSH-CABLES AND PIPE INSPECTION SYSTEMS; U.S. Pat. No. 11,550,214, issued Jan. 10, 2023, entitled SPRING ASSEMBLIES WITH VARIABLE FLEXIBLE FOR USE WITH PUSH-CABLES AND PIPE INSPECTION SYSTEMS; U.S. Pat. No. 11,558,537, issued Jan. 17, 2023, entitled VIDEO INSPECTION SYSTEM WITH WIRELESS ENABLED CABLE STORAGE DRUM; U.S. patent application Ser. No. 18/121,547, filed Mar. 14, 2023, entitled DOCKABLE CAMERA REEL AND CAMERA CONTROL UNIT (CCU) SYSTEM; U.S. patent application Ser. No. 18/121,562, filed Mar. 14, 2023, entitled PIPE INSPECTION AND CLEANING APPARATUS AND SYSTEMS; U.S. Provisional Patent Application 63/492,473, filed Mar. 27, 2023, entitled VIDEO INSPECTION AND CAMERA HEAD TRACKING SYSTEMS AND METHODS; U.S. Pat. No. 11,614,412, issued Mar. 28, 2023, entitled PIPE INSPECTION SYSTEMS WITH JETTER PUSH-CABLE; U.S. Pat. No. 11,614,613, issued Mar. 28, 2023, entitled DOCKABLE CAMERA REEL AND CCU SYSTEM; U.S. patent application Ser. No. 18/130,341, filed Apr. 3, 2023, entitled VIDEO PUSH-CABLES FOR PIPE INSPECTION SYSTEMS; U.S. Pat. No. 11,621,099, issued Apr. 4, 2023, entitled COAXIAL VIDEO PUSH-CABLES FOR USE IN INSPECTION SYSTEMS; U.S. patent application Ser. No. 18/135,661, filed Apr. 17, 2023, entitled VIDEO PIPE INSPECTION SYSTEMS AND METHODS WITH SENSOR DATA; U.S. patent application Ser. No. 18/140,488, filed Apr. 27, 2023, entitled INTEGRATED FLEX-SHAFT CAMERA SYSTEM; U.S. Pat. No. 11,639,990, issued May 2, 2023, entitled VIDEO PIPE INSPECTION SYSTEMS WITH VIDEO INTEGRATED WITH ADDITIONAL SENSOR DATA; U.S. Pat. No. 11,649,917, issued May 16, 2023, entitled INTEGRATED FLEX-SHAFT CAMERA SYSTEM WITH HAND CONTROL; U.S. patent application Ser. No. 18/203,029, filed May 29, 2023, entitled SELF-LEVELING INSPECTION SYSTEMS AND METHODS; U.S. Pat. No. 11,665,321, issued May 30, 2023, entitled PIPE INSPECTION SYSTEM WITH REPLACEABLE CABLE STORAGE DRUM; U.S. patent application Ser. No. 18/207,898, filed Jun. 9, 2023, entitled SONDE DEVICES WITH A SECTIONAL CORE; U.S. Pat. No. 11,674,906, issued Jun. 13, 2023, entitled SELF-LEVELING INSPECTION SYSTEMS AND METHODS; U.S. Provisional Patent Application 63/510,014, filed Jun. 23, 2023, entitled INNER DRUM MODULE WITH PUSH-CABLE INTERFACE FOR PIPE INSPECTION; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. patent application Ser. No. 18/490,763, filed Oct. 20, 2023, entitled LINKED CABLE-HANDLING AND CABLE-STORAGE DRUM DEVICES AND SYSTEMS FOR THE COORDINATED MOVEMENT OF A PUSH-CABLE; U.S. Provisional Patent Application 63/599,890, filed Nov. 16, 2023, entitled VIDEO INSPECTION AND CAMERA HEAD TRACKING SYSTEMS AND METHODS; U.S. patent application Ser. No. 18/528,773, filed Dec. 4, 2023, entitled PIPE INSPECTION SYSTEM CAMERA HEAD; U.S. Pat. No. 11,842,474, issued Dec. 12, 2023, entitled PIPE INSPECTION SYSTEM CAMERA HEADS; U.S. patent application Ser. No. 18/539,265, filed Dec. 14, 2023, entitled INTEGRAL DUAL CLEANER DRUM SYSTEMS AND METHODS; U.S. patent application Ser. No. 18/539,268, filed Dec. 14, 2023, entitled HIGH FREQUENCY AC-POWERED DRAIN CLEANING AND INSPECTION APPARATUS AND METHODS; U.S. Pat. No. 11,846,095, issued Dec. 19, 2023, entitled HIGH FREQUENCY AC-POWERED DRAIN CLEANING AND INSPECTION APPARATUS & METHODS; U.S. Pat. No. 11,859,755, issued Jan. 2, 2024, entitled INTEGRAL DUAL CLEANER CAMERA DRUM SYSTEMS AND METHODS; U.S. patent application Ser. No. 18/412,452, filed Jan. 12, 2024, entitled MULTI-CAMERA APPARATUS FOR WIDE ANGLE PIPE INTERNAL INSPECTION; U.S. patent application Ser. No. 18/414,785, filed Jan. 17, 2024, entitled SONDE DEVICES; United States U.S. Pat. No. 11,879,852, issued Jan. 23, 2024, entitled MULTI-CAMERA APPARATUS FOR WIDE ANGLE PIPE INTERNAL INSPECTION; and U.S. Pat. No. 11,880,005, issued Jan. 23, 2024, entitled SONDE DEVICES INCLUDING A SECTIONAL FERRITE CORE STRUCTURE. The content of each of these applications is incorporated by reference herein in its entirety.

The following exemplary embodiments are provided for the purpose of illustrating examples of various aspects, details, and functions of the present disclosure; however, the described embodiments are not intended to be in any way limiting. It will be apparent to one of ordinary skill in the art that various aspects may be implemented in other embodiments within the spirit and scope of the present disclosure. As used herein, the term, “exemplary” means “serving as an example, instance, or illustration.” Any aspect, detail, function, implementation, and/or embodiment described herein as “exemplary” is not necessarily to be construed as preferred or advantageous over other aspects and/or embodiments.

Various additional aspects, features, and functionality are further described below in conjunction with the appended Drawings.

### Terminology

As used herein, the term “ground asset” may refer to a visually identifiable object, mark, and other elements that may remain stationary and is distinguishable from the surrounding environment. Various ground assets are shown as examples in the present disclosure (e.g., manhole covers, other infrastructure covers in streets, paint markings, transitions from asphalt to concrete, and the like) but other visually identifiable objects, marks, or elements may likewise be considered “ground assets” and be marked via a ground asset utility locator device of the present disclosure. Such ground assets may frequently include visually object or markings that may be associated with buried utility lines (e.g., utility line covering or other ground surface visual indicating a particular utility line), may be useful for mapping of utility lines (e.g., a marker that may be referenced in mapping applications), and/or may influence electromagnetic fields measured at the utility locator device (e.g., objects or conductive elements in the environment that may alter electromagnetic signals or have their own electromagnetic signal).

The term “asset tagging utility locator device(s),” also referred to herein as “utility locator device(s)” for brevity, may refer to devices for measuring electromagnetic signals emitted by the one or more utility lines to determine the positions and depth of utility lines and further map utility lines as well as automatically tagging ground assets in the locating environment. Data regarding electromagnetic signals measured by an asset tagging utility locator device as “EM Data.” The EM Data may further be used in conjunction with “Geolocation Data” describing the geolocation of the utility locator device and “Orientation Data” describing the direction or heading, tilt, and pose of the utility locator device in three dimensions correlating with the Geolocation Daand to generate “Locating Data” describing the positions and depths of utility lines relative to the world frame that may include mapped utility line positions, depths, and other utility line characteristics and information.

The asset tagging utility locator devices and utility locator devices of the present disclosure likewise generate “Ground Asset Data” identifying and determining positions of ground assets. Further, the Ground Asset Data may include other characteristics and information regarding ground assets as well as map information including the positions of ground assets. The Ground Asset Data may likewise or further include images of ground assets, information regarding matching ground assets in images and ground assets in maps, “Offset Data” describing the difference in position and yaw/orientation between the ground asset in images and matching ground assets in maps, “Distance Data” measuring the distance between the asset tagging utility locator device to one or more points on the ground surface measured by a rangefinder element, orthorectification data of images, ground asset dimensions and other characteristics, and like data relating to ground assets.

The term “image plane,” or simply “plane” when referring to images generated by an imaging element in the present disclosure, may refer to a plane that is perpendicular to the optical axis of the image or image forming system (lens and imager). Generally, the plane being referred to is the imager plane but the optical axis of the lens can also matter. For instance, the image plane of images herein may be “orthorectified” or, in other words, altering images to compensate for distortions or displacements such that the images may be stretched or otherwise changed to match the spatial accuracy of a map by considering location, elevation, and sensor information.

In some systems, a “utility locating transmitter” may be used to couple current onto one or more utility lines for the purpose of generating the magnetic signals. Likewise, some systems and methods may include the use of “electronic marker devices” in a known position relative to the one or more utility lines configured to broadcast a signal when powered that may be measured at utility locator devices to determine the positions of and map the associated utility lines. Additional disclosure regarding utility locator devices and utility locating transmitters may be found in the incorporated patents and patent applications herein.

The term “GNSS” (global navigation satellite system) refers to any satellite navigation systems including, but not limited to, global positioning system (GPS), global navigation satellite system (GLONASS), BeiDou (BDS), Quasi-Zenith Satellite Systems (QZSS), and Galileo. The GNSS devices and methods described herein may further include precise point positioning real time kinematics (PPP-RTK), state space representation (SSR), and/or other like corrections.

### EXAMPLE EMBODIMENTS

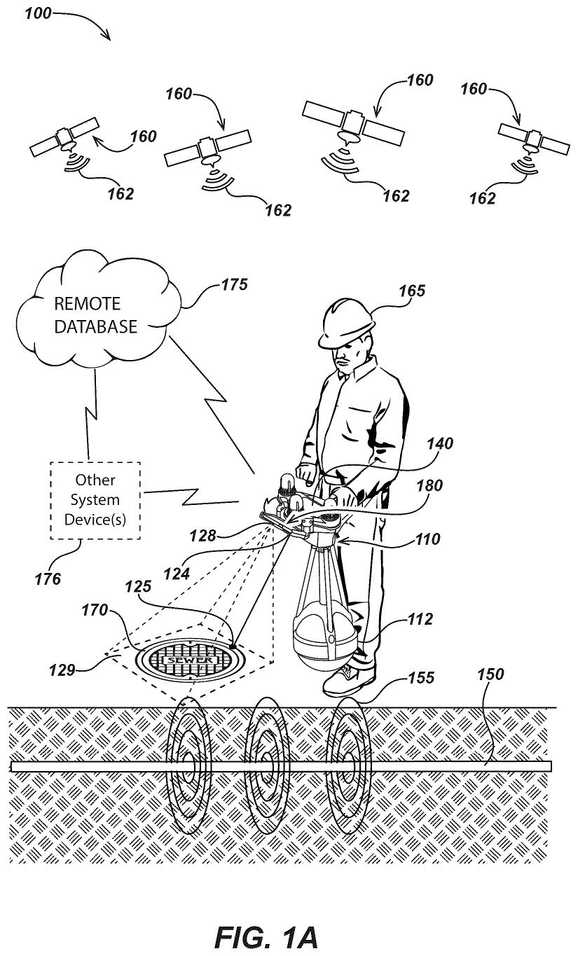

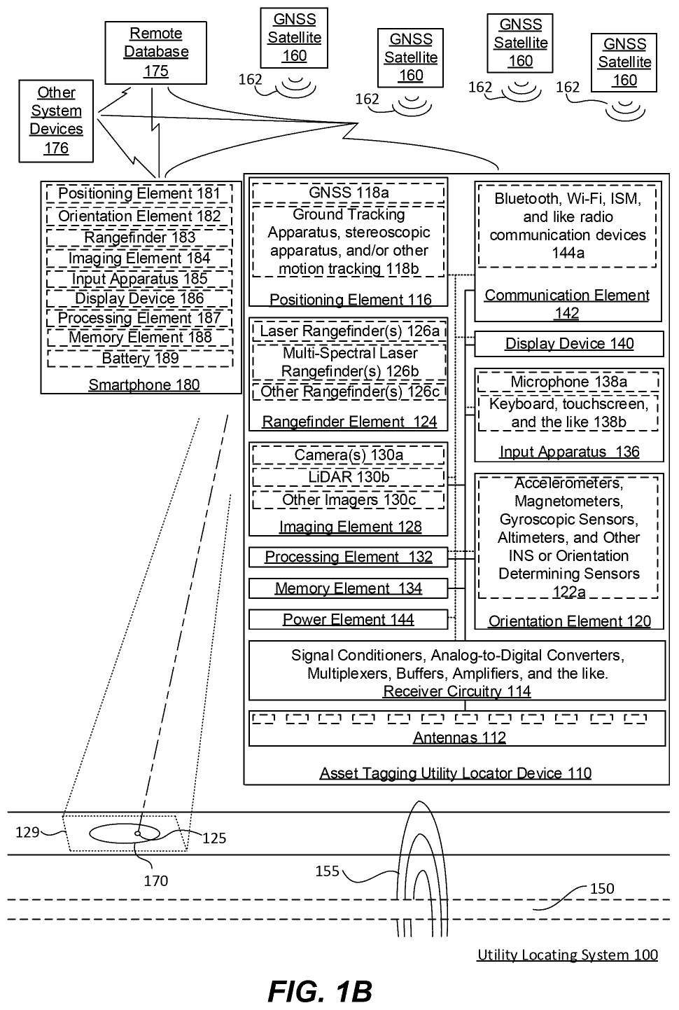

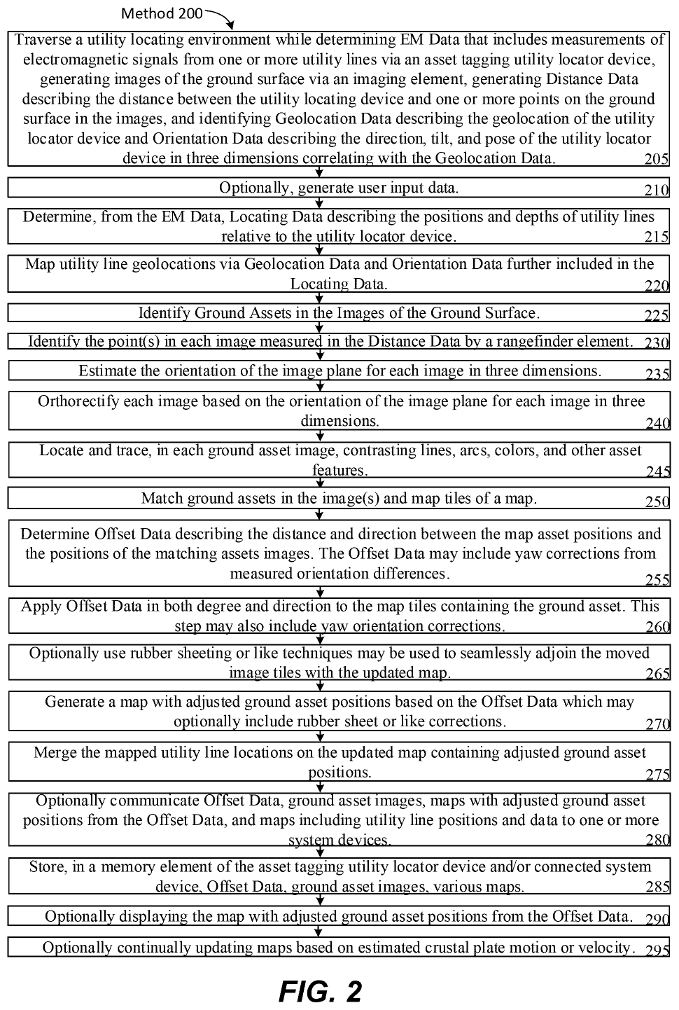

Turning to FIGS. 1A and 1B, a utility locating system 100 is illustrated including an asset tagging utility locator device 110 in keeping with the present invention. The asset tagging utility locator device 110 may include one or more antennas 112 and associated receiver circuitry 114 (FIG. 1B) to measure electromagnetic signals 155 relating to the positions of buried utility lines such as the utility line 150. It should be noted, a buried utility line, such as the utility line 150, may inherently or otherwise be made to emit a magnetic field. For instance, a power line or telecommunications line may inherently be energized and emit their own electromagnetic field signals. Other conductive utility lines may instead have current coupled thereto via a transmitter (not illustrated) or like device. Likewise, conductive utility lines may be energized via radio or like ambient signals present in the environment. Data relating to electromagnetic signals, such as the electromagnetic signals 155, measured by an asset tagging utility locator device of the present invention may be referred to herein as EM Data (e.g., the EM Data determined in the step 205 in the method 200 of FIG. 2). The asset tagging utility locator device 110, antennas 112, and associated receiver circuitry 114 (FIG. 1B) used to measure electromagnetic signals 155 may be or share aspects with the utility locator devices disclosed in U.S. patent application Ser. No. 15/360,979, filed Nov. 23, 2016, entitled UTILITY LOCATING SYSTEMS, DEVICES, AND METHODS USING RADIO BROADCAST SIGNALS; U.S. patent application Ser. No. 15/626,399, filed Jun. 19, 2017, entitled SYSTEMS AND METHODS FOR UNIQUELY IDENTIFYING BURIED UTILITIES IN A MULTI-UTILITY ENVIRONMENT; U.S. Pat. No. 9,927,545, issued Mar. 27, 2018, entitled MULTI-FREQUENCY LOCATING SYSTEMS AND METHODS; U.S. Pat. No. 9,927,546, filed Mar. 27, 2018, entitled PHASE-SYNCHRONIZED BURIED OBJECT TRANSMITTER AND LOCATOR METHODS AND APPARATUS; U.S. Pat. No. 10,078,149, issued Sep. 18, 2018, entitled BURIED OBJECT LOCATOR APPARATUS AND SYSTEMS; and U.S. Pat. No. 10,162,074, issued Dec. 25, 2018, entitled UTILITY LOCATORS WITH RETRACTABLE SUPPORT STRUCTURES AND APPLICATIONS THEREOF; U.S. Pat. No. 10,670,766, issued Jun. 2, 2020, entitled UTILITY LOCATING SYSTEMS, DEVICES, AND METHODS USING RADIO BROADCAST SIGNALS; and U.S. Pat. No. 10,564,309, filed Feb. 18, 2020, entitled SYSTEMS AND METHODS FOR UNIQUELY IDENTIFYING BURIED UTILITIES IN A MULTI-UTILITY ENVIRONMENT as well as the other utility locator devices of the incorporated applications. It should also be noted that electromagnetic signals for generating EM Data at a utility locator device may be from a tracer wire on a non-conductive utility line, a pipe Sonde, via one or more electronic marker devices, and/or like signal emitting or generating devices or elements. Though the system 100 and the present disclosure does not illustrate tracer wires, pipe Sondes, and electronic marker devices, such devices may be used in conjunction with a system and methods of the present disclosure and may be or share aspects with those disclosed in U.S. Pat. No. 7,221,136, issued May 22, 2007, entitled SONDES FOR LOCATING UNDERGROUND PIPES AND CONDUITS; U.S. patent application Ser. No. 15/681,250, filed Aug. 18, 2017, entitled ELECTRONIC MARKER DEVICES AND SYSTEMS; U.S. Pat. No. 9,746,572, issued Aug. 29, 2017, entitled ELECTRONIC MARKER DEVICES AND SYSTEMS; U.S. Pat. No. 9,798,033, issued Oct. 24, 2017, entitled SONDE DEVICES INCLUDING A SECTIONAL FERRITE CORE; U.S. patent application Ser. No. 16/449,187, filed Jun. 21, 2019, entitled ELECTROMAGNETIC MARKER DEVICES FOR BURIED OR HIDDEN USE; U.S. patent application Ser. No. 16/551,653, filed Aug. 26, 2019, entitled BURIED UTILITY MARKER DEVICES, SYSTEMS, AND METHODS; U.S. Pat. No. 10,401,526, issued Sep. 3, 2019, entitled BURIED UTILITY MARKER DEVICES, SYSTEMS, AND METHODS; U.S. patent application Ser. No. 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. No. 10,859,727, issued Dec. 8, 2020, entitled ELECTRONIC MARKER DEVICES AND SYSTEMS; U.S. patent application Ser. No. 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. Pat. No. 11,280,934, issued Mar. 22, 2022, entitled ELECTROMAGNETIC MARKER DEVICES FOR BURIED OR HIDDEN USE; U.S. Pat. No. 11,333,786, issued May 17, 2022, entitled BURIED UTILITY MARKER DEVICES, SYSTEMS, AND METHODS; and U.S. Pat. No. 11,467,317, issued Oct. 11, 2022, entitled ELECTROMAGNETIC MARKER DEVICES WITH SEPARATE RECEIVE AND TRANSMIT ANTENNA ELEMENTS; as well as the other marker devices of the incorporated applications.

Further in FIG. 1B, the asset tagging utility locator device 110 may include a positioning element 116 having one or more GNSS 118a to determine information regarding the geolocation of the asset tagging utility locator device 110 in the world frame that may be referred to herein as Geolocation Data (e.g., the Geolocation Data of the step 205 of the method 200 in FIG. 2). For instance, the GNSS 118a may receive, from a plurality of navigation satellites 160, navigation signals 162 to determine the geolocation of the asset tagging utility locator device 110. The GNSS 118a may include or be GPS, GLONASS, BeiDou, Quasi-Zenith Satellite Systems, Galileo, and the like that may further include precise point positioning real time kinematics (PPP-RTK), state space representation (SSR), and/or like corrections (not illustrated). The GNSS 118a may be or share aspects with the GNSS devices, systems, and methods disclosed the U.S. patent application Ser. No. 17/241,676, filed Apr. 27, 2021, entitled SPATIALLY AND PROCESSING-BASED DIVERSE REDUNDANCY FOR RTK POSITIONING OR OTHER POSITIONING SYSTEMS AND METHODS; U.S. patent application Ser. No. 17/461,833, filed Aug. 30, 2021, entitled COMBINED SATELLITE NAVIGATION AND RADIO TRANSCEIVER ANTENNA DEVICES; U.S. patent application Ser. No. 17/930,029, filed Sep. 6, 2022, entitled GNSS POSITIONING METHODS AND DEVICES USING PPP-RTK, RTK, SSR, OR LIKE CORRECTION DATA; and other such system, devices, and methods disclosed in the incorporated applications. Likewise, such Geolocation Data may instead or additionally include data produced via ground tracking apparatus, stereoscopic apparatus, and/or other motion tracking apparatus 118b. The ground tracking apparatus, stereoscopic apparatus, and/or other motion tracking apparatus 118b may include or be those apparatus and systems disclosed in in U.S. Pat. No. 9,341,740, issued May 17, 2016, entitled OPTICAL GROUND TRACKING APPARATUS, SYSTEMS, AND METHODS; U.S. Pat. No. 9,372,117, issued Jun. 21, 2016, entitled OPTICAL GROUND TRACKING APPARATUS, SYSTEMS, AND METHODS; U.S. patent application Ser. No. 15/187,785, filed Jun. 21, 2016, entitled BURIED UTILITY LOCATOR GROUND TRACKING APPARATUS, SYSTEMS, AND METHODS; and other devices disclosed in the incorporated applications.

The asset tagging utility locator device 110 may further include an orientation element 120 having one or more sensors and like apparatus to determine information regarding the orientation and pose of the asset tagging utility locator device 110 in the world frame. The one or more sensors and other apparatus of the orientation element 120 may be or include accelerometers, magnetometers, gyroscopic sensors, altimeters, and other inertial navigation systems (INS) or orientation determining sensors 122a. The data describing the orientation and pose of the utility locator device 110 the may be produced by the orientation element 120 may be referred to herein as Orientation Data (e.g., the Orientation Data of the step 205 of the method 200 in FIG. 2).

The asset tagging utility locator device 110 may further include a rangefinder element 124 to measure the distance between the asset tagging utility locator device 110 to one or more points on the ground surface such as the point 125. Such data may be referred to herein as Distance Data (e.g., the Distance Data of the step 205 of the method 200 in FIG. 2). It should be noted that a user, such as a user 165 (FIG. 1A), moves the asset tagging utility locator device 110 about the utility locating environment the ground surface points, such as the point 125, measured in the Distance Data by the rangefinder element 124 include distance measurements to ground assets, such as the ground asset 170. In some embodiments, rangefinder element 124 may be or include a laser rangefinder 126a, a multi-spectral laser rangefinder 126b, and/or other rangefinder device(s) 126c (e.g., other optical, acoustic, or other types of rangefinders). For instance, the rangefinder element 124 may be or share aspects with the devices and apparatuses disclosed in U.S. patent application Ser. No. 15/866,360, filed Jan. 9, 2018, entitled TRACKED DISTANCE MEASURING DEVICES, SYSTEMS, AND METHODS; U.S. patent application Ser. No. 17/845,290, filed Jun. 21, 2022, entitled DAYLIGHT VISIBLE AND MULTI-SPECTRAL LASER RANGEFINDERS AND ASSOCIATED SYSTEMS AND METHODS AND UTILITY LOCATOR DEVICES; U.S. Pat. No. 11,397,274, issued Jul. 26, 2022, entitled TRACKED DISTANCE MEASURING DEVICES, SYSTEMS, AND METHODS; and other devices disclosed in the incorporated applications. In further embodiments, the rangefinder element 124 may be or include other rangefinder apparatus (e.g., other optical rangefinders, acoustic rangefinders, and/or other types of rangefinders).

The asset tagging utility locator device 110 may further include an imaging element 128 to generate images of the ground, such as an image 129, that includes the point 125 measured via the rangefinder element 124. The imaging element 128 may include one or more cameras 130a, light detection and ranging (LiDAR) 130b, and/or other imagers 130c. The cameras 130a, other imagers 130c, or otherwise in the imaging element 128 may include high dynamic range (HDR), global shutter, and other technologies.

The asset tagging utility locator device 110 may further include a processing element 132 having one or more processors to process EM Data, Geolocation Data, and Orientation Data, Distance Data and images of the ground surface and generate Locating Data describing the positions and depths of utility lines relative to the world (e.g., the Locating Data of step 215 in method 200 of FIG. 2) and Ground Asset Data identifying and determining positions of ground assets (e.g., the Ground Asset Data of the step 250 in method 200 of FIG. 2). Further, the processing element 132 may be used to match ground asset images from the utility locating environment with like ground assets in a map of the utility locating environment, determine Offset Data describing the difference in ground asset positions from images and mapped ground asset positions in both distance and direction/heading, and moving mapped ground asset positions based on the Offset Data. The Offset Data may likewise include yaw data regarding difference in orientation of mapped ground assets and matching ground assets in the images generated via the asset tagging utility locator device 110. The Locating Data, Ground Asset Data, Offset Data, utility maps, and other associated data may be stored in a memory element 134 having one or more non-transitory memories.

The asset tagging utility locator device 110 may include one or more input apparatus 136. For instance, the input apparatus 136 may be or include a microphone 138a and/or a keyboard, touchscreen, and the like 138b allowing the user 165 (FIG. 1A) to input information. Further, the asset tagging utility locator device 110 may include one or more display devices 140 (e.g., monitor, screen, or other graphical user interface) for displaying utility lines and ground assets in positions in the world frame as well as other utility locating information.

Referring back to FIGS. 1A and 1B, an asset tagging utility locator device of the present invention may be part of a larger system including various other devices and apparatus. In the system 100, a remote database 175 and/or other system device(s) 176 and/or smartphone 180 may be configured to communicate with the asset tagging utility locator device 110 via a communication element 142. The communication element 142 may be or include Bluetooth, Wi-Fi, ISM, and like radio communication devices 144a. The asset tagging utility locator device 110 may communicate Locating Data, Ground Asset Data, ground asset images, maps, and related data with the remote database 175 for storage and/or other system device(s) 176 as well as the smartphone 180 and/or the like. The other system device(s) 176 may, for instance, include transmitter devices for coupling current on utility lines, base stations, computer devices, pipe inspection systems, and the like. Such transmitters may be or share aspects with those disclosed in the incorporated patents and applications.

Likewise, the system 100 may include a smartphone 180 in communication with and coupled to the asset tagging utility locator device 110. For instance, the smartphone 180 may mount to the asset tagging utility locator device 110 and further be in communication with the asset tagging utility locator device 110 as disclosed in U.S. Provisional Patent Application 63/514,090, filed Jul. 17, 2023, entitled SMARTPHONE MAPPING APPARATUS FOR ASSET TAGGING AS USED WITH UTILITY LOCATOR DEVICES and other devices disclosed in the incorporated applications. As shown in FIG. 1B, the smartphone 180 may include a positioning element 181 having one or more processors, an orientation element 182 (e.g., accelerometers, magnetometers, gyroscopic sensors, altimeters, and other INS or orientation determining sensors), a rangefinder 183, an imaging element 184 (which may include LiDAR as well as one or more other image sensors), an input apparatus 185 (e.g., touchscreen, microphone, or the like), and/or a display device 186 to fully or partially generate various data for the various methods of the present invention (e.g., the Geolocation Data, Orientation Data, images of the ground surface and ground assets, and Distance Data as well as processing and storing resulting Locating Data, Ground Asset Data, Offset Data, and resulting maps). Further, the smartphone 180 may include a processing element 187 having one or more processors, a memory element 188 having one or more non-transitory memories, and be powered via a battery 189. Likewise, Ground Asset Data may, in other embodiments, be generated or gathered fully or in part by one or more other devices (e.g., the other system devices 176).

Referring back to FIG. 1B, the asset tagging utility locator device 110 may include a power element 144 for portioning of electrical power to the various powered elements therein. The power element 144 may be or include a battery such as those disclosed in U.S. Pat. No. 10,090,498, issued Oct. 2, 2018, MODULAR BATTERY PACK APPARATUS, SYSTEMS, AND METHODS INCLUDING VIRAL AND/OR CODE TRANSFER and U.S. patent application Ser. No. 16/140,467, issued Sep. 24, 2018, entitled MODULAR BATTERY PACK APPARATUS, SYSTEMS, AND METHODS INCLUDING VIRAL AND/OR CODE TRANSFER; U.S. patent application Ser. No. 16/520,248, issued Jul. 23, 2019, entitled MODULAR BATTERY PACK APPARATUS, SYSTEMS, AND METHODS INCLUDING VIRAL AND/OR CODE TRANSFER, and U.S. patent application Ser. No. 16/837,923, issued Apr. 1, 2020, entitled MODULAR BATTERY PACK APPARATUS, SYSTEMS, AND METHODS INCLUDING VIRAL AND/OR CODE TRANSFER the contents of which are incorporated by reference herein in their entirety.

Turning to FIG. 2, an asset tagging method 200 is illustrated for use in utility locating. It should be noted that the method 200 may be performed in real-time, near real-time, or in post processing. Further, it should also be noted that unlike prior art devices, systems, and methods for tagging of ground assets, the methods and associated devices and systems disclosed herein may be performed automatically with little to no hassle to a user, such as the user 165 of FIG. 1A, beyond optionally allowing for user input (e.g., the user input of the optional step 210). For instance, in the method 200 and other methods, devices, and systems of the present disclosure, data relating to ground assets may automatically be collected by an asset tagging utility locator device without any necessary input from a user during a utility locating operation.

In a step 205, the method 200 may include traversing a utility locating environment while determining EM Data that includes measurements of electromagnetic signals from one or more utility lines via an asset tagging utility locator device, generating images of the ground surface via an imaging element, generating Distance Data describing the distance between the utility locating device and one or more points on the ground surface in the images, and identifying Geolocation Data describing the geolocation of the utility locator device and Orientation Data describing the direction/heading, tilt, and pose of the utility locator device in three dimensions correlating with the Geolocation Data. In an optional step 210, the method 200 may include input from a user. In such a step, as a rangefinder element is measuring to a point or points on a ground asset, a user may input information regarding a ground asset. The notation of the presence and/or descriptions of ground assets, notate related information, information regarding association with buried utility lines, and the like may be input via one or more input apparatus (e.g., a microphone, keyboard, or like apparatus to input information).

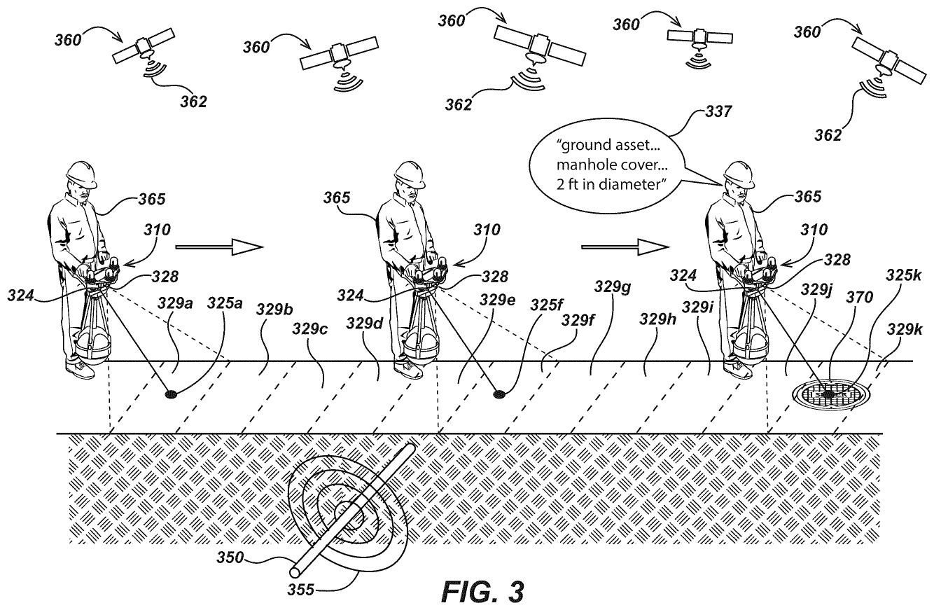

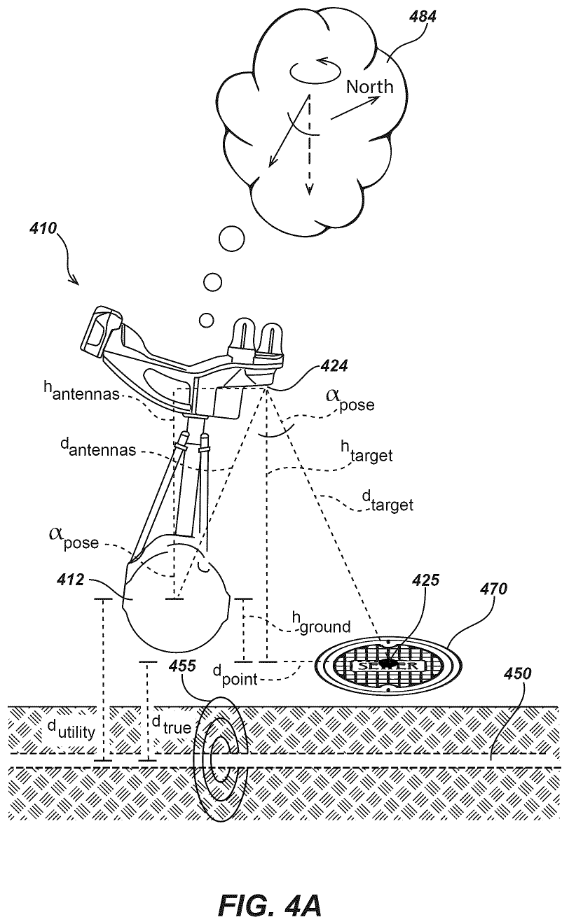

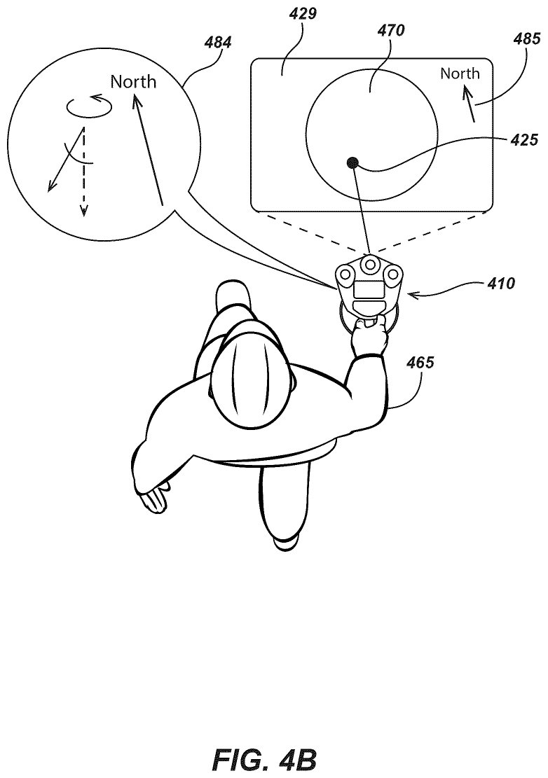

The steps 205 and 210 of the method 200 from FIG. 2 are further illustrated in FIG. 3. As illustrated in FIG. 3, a user 365 may traverse a utility locating environment equipped with an asset tagging utility locator device 310. The asset tagging utility locator device 310 may be or share aspects with the asset tagging utility locator device 110 of FIGS. 1A and 1B. As the user 365 traverses the utility locating environment, data is generated via the utility locator device 310 regarding buried utility lines via electromagnetic signals (e.g., a utility line 350 via an electromagnetic signal 355) and ground assets (e.g., a ground asset 370). For instance, the asset tagging utility locating device 310 may generate EM Data that includes measurements of the electromagnetic signals 355 from the utility line 350, generating images of the ground surface via an imaging element such as the images 329a-329k via an imaging element 328 (which may be or share aspects with the imaging element 128 of FIGS. 1A and 1B), generating Distance Data describing the distance between the utility locating device 310 and one or more points, such as the points 325a, 325f, or 325k on the ground surface in the images 329a and 329f and 329k respectively via a rangefinder element 324 (which may be or share aspects with the rangefinder element 124 of FIGS. 1A and 1B), and identifying Geolocation Data describing the geolocation of the utility locator device 310 from a plurality of navigation signals 362 broadcast by a plurality of navigation satellites 360 and Orientation Data describing the direction/heading, tilt, and pose of the utility locator device 310 in three dimensions from an orientation element in the utility locator device 310 correlating with the Geolocation Data. Such Orientation Data may be illustrated in FIGS. 4A and 4B. It should also be noted that one or more points would generally be measured in each image 329a-329k. It should also be noted that in some embodiments, the frequency of images produced may cause the images to overlap or, in other embodiments, be generated at a frequency causing the images to be spaced apart. As further shown in FIG. 3, upon the user 365 identifying a ground asset 370, the user 365 may provide user input 337. For instance, the user 365 may speak into a microphone identifying a ground asset and provide a description of that ground asset. Likewise, in some embodiments, other forms of user input may be used (e.g., via a keyboard, touchscreen, or the like).

Turning to FIGS. 4A and 4B, an asset tagging utility locator device 410 is illustrated which may be or share aspects with the asset tagging utility locator device 110 of FIGS. 1A and 1B and the asset tagging utility locator device 310 of FIG. 3. The asset tagging utility locator device 410 may generate Orientation Data 484 relating to the orientation and pose of the asset tagging utility locator device 410. For instance, the Orientation Data 484 may be generated by an orientation element (e.g., the orientation element 118 of the asset tagging utility locator device 110 and/or the orientation element 182 of the smartphone 180) having one or more accelerometers, magnetometers, gyroscopic sensors, altimeters, and other INS or orientation determining sensors. The Orientation Data 484 may be or share aspects with the Orientation Data determined in the step 205 of the method 200 of FIG. 2.

Turning to FIG. 4B, it should be noted that the Orientation Data 484 may include a heading (e.g., cardinal direction or the like) such that a ground asset 470 captured in a ground surface image 429 that may likewise have a heading orientation 485 that may be determined from the Orientation Data 484 generated via the asset utility locator device 410 as carried by a user 465.

Referring back to FIG. 4A, the asset tagging utility locator device 410, having a rangefinder element 424, may determine positions of the point 425 which may be on the ground asset 470 having Orientation Data 484 including the heading orientation 485 (FIG. 4B). The asset tagging utility locator device 410 may, via the rangefinder element 424, determine a distance d_{target} from the rangefinder 424 to the point 425 on the ground asset 470. A height, notated as h_{target}, may describe the vertical distance of the rangefinder 424 from the ground surface relative to the point 425 on the ground asset 470. An angle αₚₒₛₑ may describe the angle from the height h_{target} toward the point 425 as determined via the orientation/pose of the asset tagging utility locator device 410 (via the Orientation Data determined via an orientation element).

It should be noted that a distance dₐₙₜₑₙₙₐₛ between the rangefinder and sense antennas of the asset tagging utility locator device 410 may be known as both exist in the same rigid body of the asset tagging utility locator device 410. A height hₐₙₜₑₙₙₐₛ may describe the vertical distance from the rangefinder 424 to the antenna array 412 of the asset tagging utility locator device 410.

The antenna array 412 may sense magnetic fields 455 from one or more utility lines in the ground, such as a utility line 450, in determining the location and orientation/pose thereof. Likewise, a depth measurement, notated herein as d_{utility}, may be determined measuring between the antenna array 412 and the utility line 450.

The position of the point 425, and thereby the ground asset 470, relative to the asset tagging utility locator device 410, notated as dₚₒᵢₙₜ, may be determined by dₚₒᵢₙₜ=d_{target}*sin αₚₒₛₑ further having a known heading orientation 485 determined from the Orientation Data 480.

Turning back to FIG. 2, the method 200 may include a step 215 determining, from the EM Data, Locating Data describing the positions and depths of utility lines relative to the utility locator device. In another step 220, the method 200 includes mapping utility line geolocations via Geolocation Data and Orientation Data further included in the Locating Data. The step 220 may, for instance utilize or include the map generation methods disclosed in U.S. patent application Ser. No. 16/701,085, filed Dec. 2, 2019, entitled MAP GENERATION BASED ON UTILITY LINE POSITION AND ORIENTATION ESTIMATES the contents of which is incorporated by reference herein in its entirety. Further information regarding methods and associated devices and systems for locating and mapping buried utility lines may be found in those disclosed in U.S. patent application Ser. No. 15/360,979, filed Nov. 23, 2016, entitled UTILITY LOCATING SYSTEMS, DEVICES, AND METHODS USING RADIO BROADCAST SIGNALS; U.S. patent application Ser. No. 15/626,399, filed Jun. 19, 2017, entitled SYSTEMS AND METHODS FOR UNIQUELY IDENTIFYING BURIED UTILITIES IN A MULTI-UTILITY ENVIRONMENT; U.S. Pat. No. 9,927,545, issued Mar. 27, 2018, entitled MULTI-FREQUENCY LOCATING SYSTEMS AND METHODS; U.S. Pat. No. 9,927,546, filed Mar. 27, 2018, entitled PHASE-SYNCHRONIZED BURIED OBJECT TRANSMITTER AND LOCATOR METHODS AND APPARATUS; U.S. Pat. No. 10,078,149, issued Sep. 18, 2018, entitled BURIED OBJECT LOCATOR APPARATUS AND SYSTEMS; and U.S. Pat. No. 10,162,074, issued Dec. 25, 2018, entitled UTILITY LOCATORS WITH RETRACTABLE SUPPORT STRUCTURES AND APPLICATIONS THEREOF; U.S. Pat. No. 10,670,766, issued Jun. 2, 2020, entitled UTILITY LOCATING SYSTEMS, DEVICES, AND METHODS USING RADIO BROADCAST SIGNALS; and U.S. Pat. No. 10,564,309, filed Feb. 18, 2020, entitled SYSTEMS AND METHODS FOR UNIQUELY IDENTIFYING BURIED UTILITIES IN A MULTI-UTILITY ENVIRONMENT as well as the other utility locator devices of the incorporated applications.

The method 200 may include a step 225 identifying ground assets in the ground surface images. The step 225 may, for instance, utilize the user input from step 210 and/or, in some embodiments, image recognition or like algorithms may be used to identify possible ground assets in the images of the ground surface. In another step 230, the method 200 may include identifying the point or points in each image measured in the Distance Data by a rangefinder element. For instance, the rangefinder element may be a laser rangefinder or multi-spectral laser rangefinder that may produce one or more dots or points in the ground surface image.

In another step 235, the method 200 may include estimating the orientation of the image plane for each image in three dimensions. The method 200 may further include a step 240 orthorectifying each image based on the orientation of the image plane for each image in three dimensions. For instance, in the steps 235 and 240 the orthorectification of image planes may include utilizing collected data (e.g., ground asset images, Geolocation Data, Orientation Data, Distance Data) as well as various orthorectification algorithms (e.g., polynomial rectification, projective rectification, differential rectification, sensor model rectification, rational model function rectification, orthorectification reprojection, general orthorectification overflow, and the like) to determine the orientation of the image plane in three dimensions and orthorectifying each image.

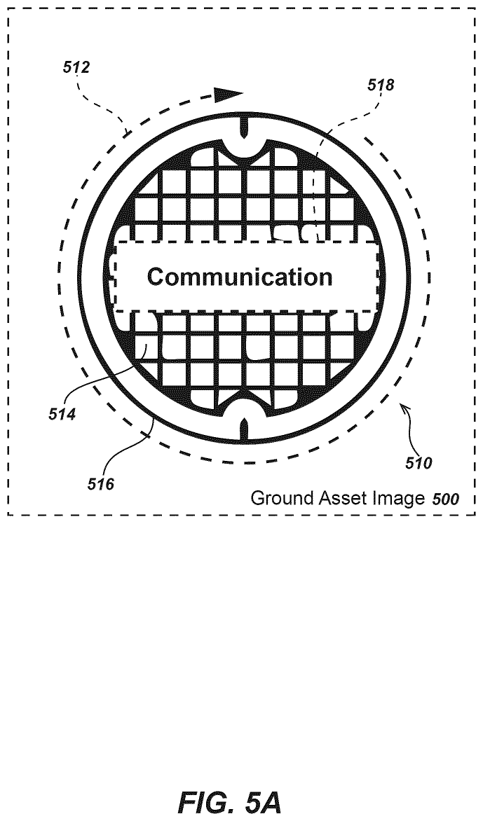

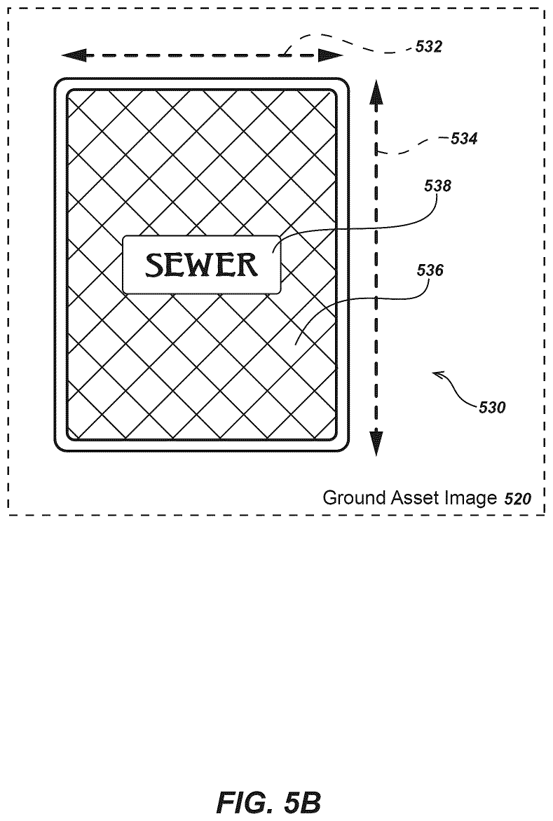

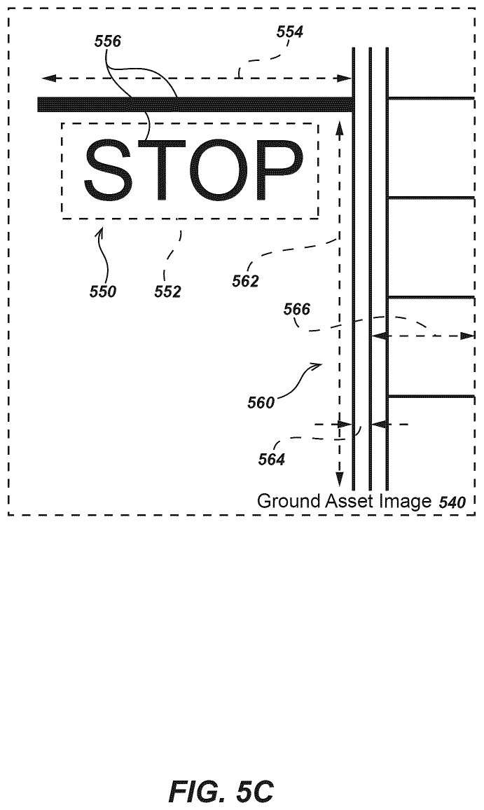

The method 200 further includes a step 245 locating and tracing, in each ground asset image, contrasting lines, arcs, colors, and other asset features. For instance, ground asset features may be located and virtually traced in software. The step 240 is better illustrated in FIGS. 5A, 5B, and 5C.

As illustrated in FIGS. 5A, 5B, and 5C a series of example ground asset image such as a ground asset image 500 (FIG. 5A), a ground asset image 520 (FIG. 5B), and a ground asset image 540 (FIG. 5C) are illustrated. It should be noted that the ground asset images 500 (FIG. 5A), the ground asset image 520 (FIG. 5B), and the ground asset image 540 (FIG. 5C) depict a few examples of a ground assets. Any visually identifiable object, mark, or element that may remain stationary and is distinguishable from the surrounding environment may be considered a “ground asset.”

As illustrated in FIG. 5A, in the ground asset image 500, the depicted manhole cover may be identified as a ground asset 510. The dimensions of the ground asset 510 may be traced as illustrated via a trace line 512. Further, other ground asset features may be identified including the color and texture difference of a manhole cover 514 and a manhole lip 516 in contrast to the road surface. Further, text, such as a text line 518, may be traced and further understood via image recognition or like algorithms to identify the manhole cover as relating to “communication” utilities.

Turning to FIG. 5B, the ground asset image 520 may include a ground asset 530 which may be a trench plate. The dimensions of the trench plate ground asset 530 may be traced as illustrated via a trace line 532 and a trace line 534. Further, other ground asset features may be identified including a color and texture 536 that may contrast with the color and texture of the street or other surrounding environment. Further still, any text, such as a text line 538, may be traced and further understood via image recognition or like algorithms to identify the trench plate ground asset 530 as relating to “sewer” lines.

Turning to FIG. 5C, the ground asset image 540 may include a plurality of ground assets, such as a ground asset 550 and a ground asset 560. The ground asset 550 may include paint marks associated with a stop sign. The dimensions of the paint mark ground asset 550 may be traced as illustrated via a series of trace lines 552 and a trace line 554. Likewise, a color and texture 556 of the paint mark ground asset 550 may be identified that may contrast with the color and texture of the street or other surrounding environment. Further still, the “stop” of the trace lines 552 of the ground asset 550 may be understood via image recognition or like algorithms to identify the ground asset 550 as relating to a “stop” sign.

The ground asset 560 may include a transition from the street to sidewalk. The dimensions of the ground asset 560, having a difference in color and texture from the street, may be traced as illustrated via a trace line 562. Further, an elevation change 564 from street to sidewalk level and a sidewalk width 566 may be determined.

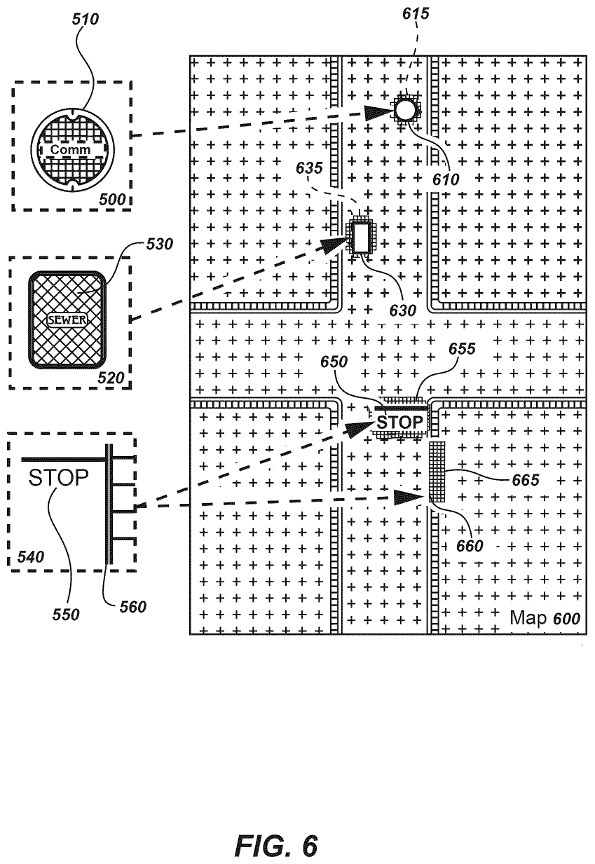

Turning back to FIG. 2, the method 200 further includes a step 250 locating, in one or more image tiles of a digital map that includes the utility locating environment, matching asset features in image tiles of the map of and the images generated by the imaging element of the asset tagging utility locator device. For instance, one or more image matching algorithms (e.g., scale-invariant feature transform, speed-up robust features, fast and accelerated segment test, binary robust independent elementary features, oriented fast and rotated binary robust independent elementary features, and/or the like) may be used to match ground asset images to that in a map. The step 250 is further illustrated in FIG. 6.

Turning to FIG. 6, a map 600 is illustrated that includes various ground assets matching those identified in the images generated by a asset tagging utility locator device. For instance, the image 500 including the ground asset 510 may have features matching the ground asset 610 in the image tiles 615, the image 520 including the ground asset 530 may have features matching the ground asset 630 in the image tiles 635, and the image 540 including the ground asset 550 and the ground asset 560 may have features matching the ground asset 650 in the image tiles 655 and the ground asset 660 in the image tiles 665 respectively.

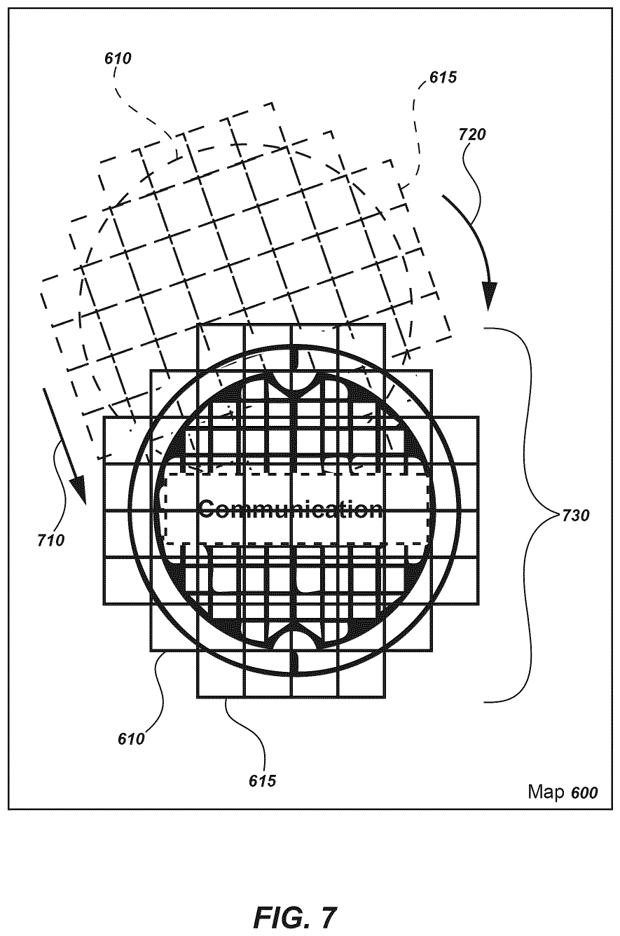

Referring back to FIG. 2, the method 200 may further include a step 255 determining Offset Data describing the distance and direction between the map asset positions and the positions of the matching asset in the images generated by the imaging element of the utility locator device. The Offset Data may include yaw orientation corrections. In another step 260, the method 200 includes applying Offset Data in both degree and direction to the map tiles containing the ground asset. This step may also include yaw orientation corrections. In an optional step 265, rubber sheeting or like techniques may be used to seamlessly adjoin the moved image tiles with the updated map. The steps 255, 260, and 265 are further illustrated in FIG. 7.

Turning to FIG. 7, a detailed view of the map 600 is illustrated. The Offset Data determined in the step 255 and applied in the step 260 of the method 200 (FIG. 2) may include both a translation correction 710 and a yaw correction 720 moving and reorienting the image tiles 615 containing the ground asset 610 to an updated position 730. Optionally, where rubber sheeting or like techniques may be used to seamlessly adjoin the image tiles 615 with the map 600 in the updated position 730.

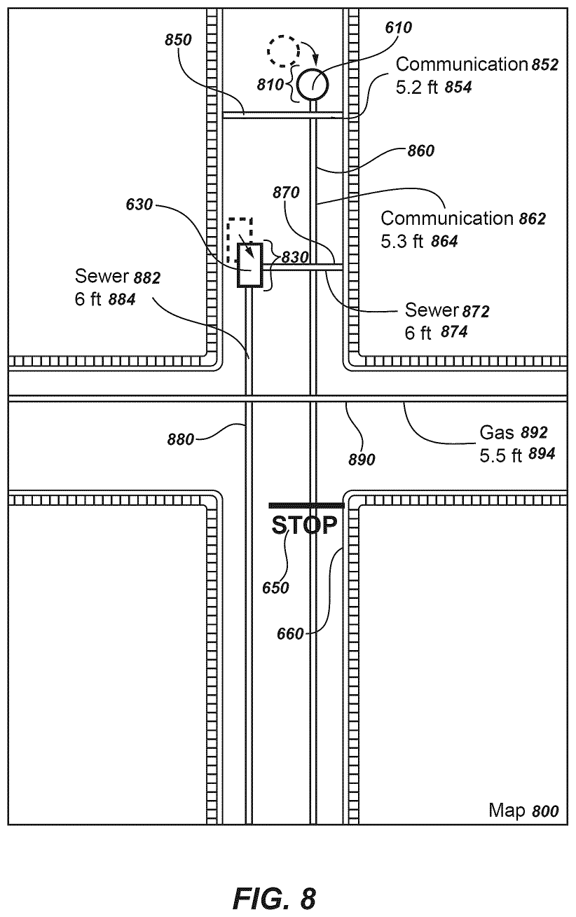

Referring back to FIG. 2, the method 200 may further include a step 270 generating a map with adjusted ground asset positions based on the Offset Data. In a step 275, the method 200 may include merging mapped utility line locations on the updated map containing adjusted ground asset positions. The merging of maps may include the use of methods disclosed in U.S. Pat. No. 11,561,317, issued Jan. 24, 2023, entitled GEOGRAPHIC MAP UPDATING METHODS AND SYSTEMS the contents of which is incorporated by reference herein in its entirety. The steps 270 and 275 are further illustrated in FIG. 8.

Turning to FIG. 8, a map 800, which may be a digital map for visually showing on a display device (e.g., the display device 140 of the asset tagging utility locator device 110 of FIGS. 1A and 1B and/or the display device 186 of the smartphone 180 of FIG. 1B and/or other system device having a display element), is illustrated having various ground assets with corrected positions as well as merging utility line positions and data. For instance, the map 800 may include the ground assets 610 and 630 which may have be translated to updated positions 810 and 830 respectively which may include yaw correction to orientations of ground assets (e.g., the ground asset 810). Further, the map 800 may include ground assets 650 and 660 that required no correction. The map 800 may include a number of utility line positions, such as a utility line 850, 860, 870, 880, and 890. As illustrated each of the utility lines 850, 860, 870, 880, and 890 may include a depth measurement, such as a depth measurement 854, 864, 874, 884, and 894 as well as other data. The other data may be or include a utility line type 852, 862, 872, 882, and 892 as illustrated and/or other information that may be related to the utility line. For instance, the utility line 850 may be identified by the utility line type 852 as “sewer” based on upon EM Data measured in the step 205 and/or associated ground asset data such as the user input data of the step 210 and/or image recognition applied to image data in the step 240. Likewise, the utility type classification may come from historical data of mapped utility lines at the geolocation (e.g., from data generated during installation of utility lines, prior excavation or potholing of utility lines at the geolocation, other utility locating and mapping procedures, or the like).

Referring back to FIG. 2, the method 200 may optionally include a step 280 communicating Offset Data, ground asset images, maps with adjusted ground asset positions from the Offset Data, and maps including utility line positions and data to one or more system devices (e.g., the remote database 175 of FIGS. 1A and 1B and/or the smartphone 180 of FIGS. 1A and 1B and/or other system device(s) 176 of FIGS. 1A and 1B which may be or include laptops or other computer devices and/or transmitter devices and the like).

The method 200 may include a step 285 storing, in a memory element (e.g., the memory element 134 of the asset tagging utility locator device 110 of FIG. 1B and/or the memory element 134 of the smartphone 180 in FIG. 1B and/or a memory element in the remote database 175 of FIGS. 1A and 1B and/or other system device(s) 176 of FIGS. 1A and 1B), Offset Data, ground asset images, maps with adjusted ground asset positions from the Offset Data, and maps including utility line positions and data to one or more system devices. In an optional step 290, the method 200 may include displaying the map with adjusted ground asset positions from the Offset Data. For instance, the map 800 illustrated in FIG. 8 may be displayed on the display device 140 of the asset tagging utility locator device 110 of FIGS. 1A and 1B and/or the display device 186 of the smartphone 180 of FIG. 1B and/or other system device having a display element. In another optional step 295, the method 200 may include continually updating maps based on estimated crustal plate motion or velocity. For instance, a map, such as the map 800, may merge with maps showing crustal plate movement on a predetermined interval and/or update based on algorithms estimating crustal plate movement/velocity.

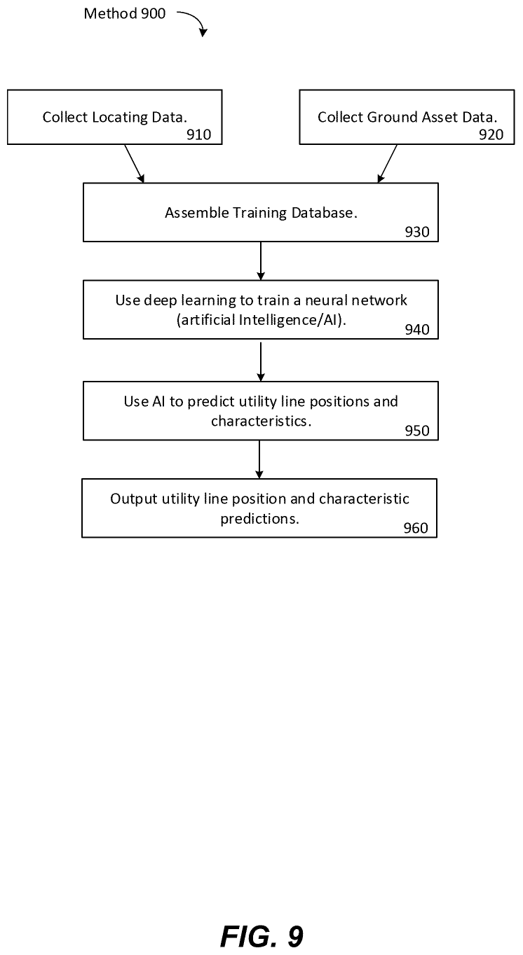

Turning to FIG. 9, a method 900 is disclosed for providing Ground Asset Data and Locating Data to a Neural Network and using Deep Learning/artificial intelligence (AI) to recognize patterns and make predictions related to utility lines. The method 900 may include a step 910 collecting Locating Data describing the positions and depths of utility lines in the ground from electromagnetic signals via a utility locator device. The Locating Data may include but should not be limited to utility line positions, utility line depths, maps of the utility locating environment including utility line positions and depths, and/or identification information regarding utility line types. In another step 920, the method 900 may include collecting Ground Asset Data from identifiable characteristics revealed when a utility line is exposed in a pothole via a potholing mapping apparatus of the present invention. The Ground Asset Data may include but should not be limited to images of one or more ground assets, geolocations of ground assets, and/or dimensions of ground assets, identification information regarding ground assets. In another step 930, the method 900 may include assembling a Training Database that includes Locating Data and Ground Asset Data. The Training Database may further include includes one or more maps of the utility locating environment, user input data, and/or other data. In another step 940, the method 900 may include using deep learning to train a Neural Network (Artificial Intelligence/AI) via the Training Database Data. In a step 950, the method may include generating predictions regarding the positions of utility lines and utility line characteristics via AI. In some embodiments, the AI may generate predictions regarding mapping positions of utility lines, the association between ground assets and buried utility lines, and/or other predictions regarding utility lines. In another step 960, the method 900 may include outputting predictions regarding the positions of utility lines and characteristics. The AI may, for instance, generate predictions regarding mapping utility lines and the association between ground assets and buried utility lines.

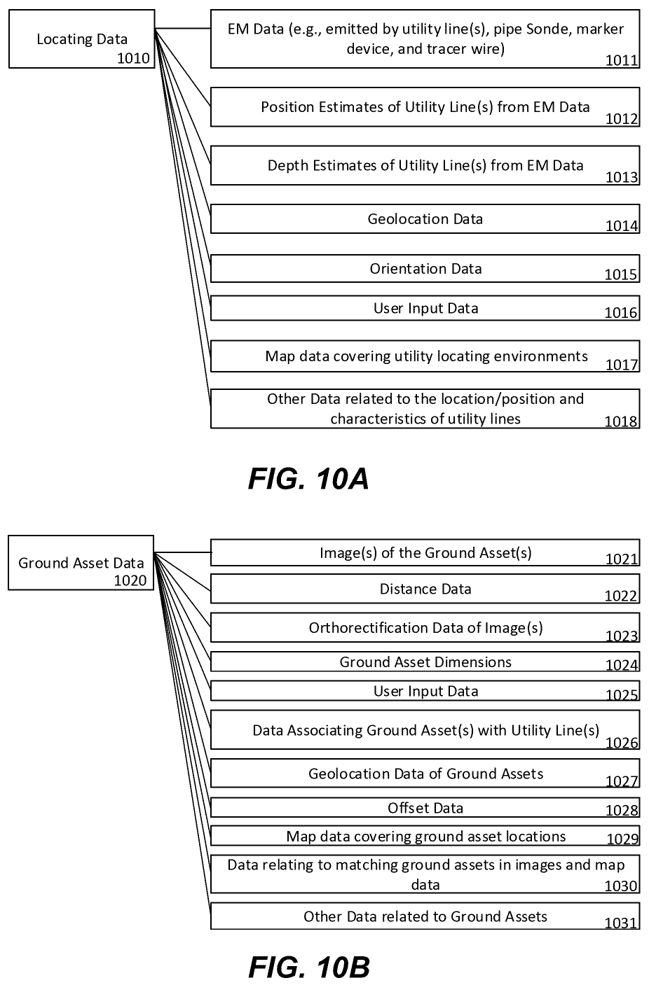

Turning to FIG. 10A, Locating Data 1010 is illustrated showing a plurality of example sources of data that may be used to train Neural Networks. As illustrated, the Locating Data 1010 may include, but should not be limited to, EM Data (e.g., emitted by utility line(s), pipe Sonde, marker device, and tracer wire) 1011, position estimates of utility lines from EM Data 1012, depth estimates of utility line(s) from EM Data 1013, Geolocation Data 1014 (e.g., geolocations in the world coordinate system as determined via the positioning element 116 of FIG. 1B, positioning element 181 of the smartphone 180 of FIG. 1B and/or other connected device), Orientation Data 1015 (e.g., a heading, orientation, direction, tilt, and pose determined via the orientation element 120 of FIG. 1B and/or orientation element 182 of the smartphone 180 of FIG. 1B and/or other connected device), User Input Data 1016 (e.g., user generated information regarding utility lines and related information provided via the input apparatus 136 of FIG. 1B and/or input apparatus 185 of the smartphone 180 of FIG. 1B and/or other connected device), map data covering the utility locating environment 1017 (e.g., digital or other maps that include the area or areas scanned in a locating operation), and/or other data related to the location/position and characteristics of utility lines 1018. It should be noted that the Locating Data 1010 may be or share aspect with the Locating Data 910 of FIG. 9 as well as the Locating Data disclosed in the steps 215 and 220 of the method 200 if FIG. 2.

Turning to FIG. 10B, Ground Asset Data 1020 is illustrated showing a plurality of example sources of data that may be used to train Neural Networks. As illustrated, the Ground Asset Data 1020 may include, but should not be limited to, images of the ground assets 1021 (e.g., images determined via the imaging element 128 of FIG. 1B and/or other connected device that may include the point or points measured by a rangefinder element), Distance Data (e.g., determine via the rangefinder element 124), orthorectification data of images 1023, ground asset dimensions 1024, User Input Data 1025 (e.g., user generated information regarding ground assets and related information provided via the input apparatus 136 of FIG. 1B and/or input apparatus 185 of the smartphone 180 of FIG. 1B and/or other connected device), data associating ground assets with buried utility lines 1026 (e.g., text or other indicators determined in images that have known association with utility line types or other utility line information), geolocation data of ground assets 1027 (e.g., the geolocation of ground assets as determined through Geolocation Data from a positioning element, Orientation Data from an orientation element, and Distance Data of a rangefinder element), Offset Data 1028 (e.g., the Offset Data determined in the step 255 of the method 200), map data covering the utility locating environment 1029 (e.g., digital or other maps that include the area or areas including ground asset positions), data relating to matching ground assets in images and map data 1030 (e.g., digital or other maps that include the area or areas including ground asset positions), and other data related to ground assets 1031. It should be noted that the Ground Asset Data 1020 may be or share aspects with the Ground Asset Data disclosed in the steps 225-290 of the method 200 if FIG. 2.

In one or more exemplary embodiments, the electronic features and functions described herein and associated with the positioning devices, systems, and methods may be implemented in hardware, software, firmware, or any combination thereof. If implemented in software, the functions may be stored on or encoded as one or more instructions or code on a computer-readable medium. Computer-readable medium includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, solid state drives (SSD), USB flash drives or other similar portable devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable medium. As used herein, computer program products comprising computer-readable media include all forms of computer-readable media except to the extent that such media is deemed to be non-statutory, transitory propagating signals.

Those of skill in the art would understand that information and signals, such input/output signals or data, and/or other signals/other data may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Skilled artisans may implement the described functionality in varying ways for each particular application, but such implementation decisions should not be interpreted as causing a departure from the scope of the present disclosure.

The various illustrative functions and circuits described in connection with the embodiments disclosed herein may be implemented or performed in a processing element with a general purpose processor, a digital signal processor (DSP), an application specific integrated circuit (ASIC), a field programmable gate array (FPGA) or other programmable logic device, discrete gate or transistor logic, discrete hardware components, memory devices, and/or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Processing elements, as used herein, may also include networked computers or computing systems, cloud-based computing, machine learning, and Artificial Intelligence (AI) systems. It is foreseeable that other processing systems, methods, and devices not listed here could be used by one of ordinary skill in the art to accomplish processing, computing, and memory tasks and functions.

The features described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known or developed in the art. An exemplary storage medium is coupled to the processor such that the processor can read information from, and write information to, the storage medium. In the alternative, the storage medium may be integral to the processor.

The scope of the present invention is not intended to be limited to the aspects shown herein, but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use embodiments of the presently claimed invention. Various modifications to these aspects will be readily apparent to those skilled in the art, and the generic principles defined herein may be applied to other aspects without departing from the spirit or scope of the disclosures herein. Thus, the scope of the present disclosure is not intended to be limited to only the specific aspects shown herein but should be accorded the widest scope consistent with the embodiments herein and their equivalents.

1. An asset tagging method for use in utility locating, comprising:
traversing a utility locating environment while determining EM Data that includes measurements of electromagnetic signals via an asset tagging utility locator device, generating images of the ground surface via an imaging element, generating Distance Data describing the distance between the utility locating device and one or more points on the ground surface in the images, and identifying Geolocation Data describing the geolocation of the utility locator device and Orientation Data describing the direction/heading, tilt, and pose of the utility locator device in three dimensions correlating with the Geolocation Data;
determining, from EM data, Locating Data describing the positions and depths of utility lines relative to the utility locator device;
mapping utility line geolocations via Geolocation Data and Orientation Data further included in the Locating Data;
identifying ground assets in the ground surface images;
identifying the point(s) in each image measured in the Distance Data by a rangefinder element;
estimating the orientation of the image plane for each image in three dimensions;
orthorectifying each image based on the orientation of the image plane for each image in three dimensions;
locating and tracing, in each ground asset image, contrasting lines, arcs, colors, and other asset features;
locating, in image tiles of a map of the utility locating environment, matching asset features in image tiles of a map of the utility locating environment and the images generated by the imaging element of the utility locator device;
determining Offset Data describing the distance and direction between the map asset positions and the positions of matching asset in the images generated by the imaging element of the utility locator;
applying Offset Data in both degree and direction to the map tiles containing the ground asset;
generating an updated map with adjusted ground asset positions from the Offset Data;
merging mapped utility line locations on the updated map containing adjusted ground asset positions; and
storing, in a memory element, Offset Data, ground asset images, maps with adjusted ground asset positions from the Offset Data, and maps including utility line positions and data to one or more system devices, and associated data.

2. The asset tagging method of claim 1, wherein the Offset Data includes yaw orientation corrections.

3. The asset tagging method of claim 2, wherein the yaw orientation of the Offset Data is used to correct orientation of ground assets.

4. The asset tagging method of claim 1, wherein asset positions are continually updated on the map based on estimated crustal plate motion or velocity.

5. The asset tagging method of claim 1, further including inputting data from a user.

6. The asset tagging method of claim 1, further including displaying the map with adjusted ground asset positions from the Offset Data.

7. The asset tagging method of claim 1, further including communicating the Offset Data, ground asset images, and map with adjusted ground asset positions from the Offset Data to one or more system devices for display and storage.

8. The asset tagging method of claim 1, wherein the method is performed in real-time or near real-time.

9. The asset tagging method of claim 1, wherein the method is performed in post processing.

10. The asset tagging method of claim 1, wherein the merged map containing adjusted ground asset positions and utility line positions further includes utility line depths.

11. The asset tagging method of claim 1, wherein the merged map containing adjusted ground asset positions and utility line positions further includes other information regarding the utility lines.

12. An asset tagging utility locator device, comprising:
one or more antennas and associated receiver circuitry to determine EM Data measuring electromagnetic signals related to the positions of one or more buried utility lines relative to the utility locator device;
a positioning element having one or more apparatus to determine Geolocation Data describing the geolocation of the utility locator device;
an orientation element including one or more sensors to determine Orientation Data describing the direction/heading, tilt, and pose of the utility locator device in three dimensions correlating with the Geolocation Data;
a rangefinder element to determine Distance Data describing the distance between the utility locating device and one or more points on the ground in the utility locating environment as the utility locator device is moved about the utility locating environment;
an imaging element to generate images the ground that includes the point(s) associated with the Distance Data while the utility locator device is moved about the utility locating environment;
a processing element having one or more processors to generate Locating Data describing the positions and depths of utility lines relative to the world from the EM Data, Geolocation Data, and Orientation Data; generate Ground Asset Data identifying and determining positions of ground assets from images of ground assets, Distance Data, Geolocation Data, and Orientation Data; identify matching ground assets in a map of the utility locating environment; determine Offset Data describing the difference in ground asset geolocations determined by the asset tagging utility locator device and ground asset geolocations in the map in both distance and direction; and moving mapped ground asset positions based on Offset Data;
a memory element having one or more non-transitory memories to store Locating Data, Ground Asset Data, Offset Data, utility maps, and other associated data; and
a power element for portioning of electrical power to the various powered elements.

13. The asset tagging locator device of claim 12, further including a smartphone coupled to and in communicating with the utility locator.

14. The asset tagging locator device of claim 13, wherein the imaging element is disposed in the smartphone.

15. The asset tagging locator device of claim 12, wherein the imaging element includes light detection and ranging (LiDAR).

16. The asset tagging locator device of claim 12, wherein the orientation element includes one or more of an accelerometer, a magnetometer, a gyroscopic sensor, an altimeter, and/or another inertial navigation apparatus or system (INS).

17. The asset tagging locator device of claim 13, wherein the orientation element is in the smartphone.

18. The asset tagging locator device of claim 12, wherein the positioning element includes one or more global navigation satellite system (GNSS) receivers and antennas.

19. The asset tagging locator device of claim 13, wherein the positioning element is in the smartphone.

20. The asset tagging locator device of claim 12, wherein the rangefinder element is a laser rangefinder.

21-28. (canceled)

29. A computer implemented method for utility line positions and characteristics using Artificial Intelligence (AI) comprising:
collecting Locating Data describing the positions and depths of utility lines in the ground from electromagnetic signals via a utility locator device;
collecting Ground Asset Data from ground surface images and digital maps of utility locating environment;
assembling a Training Database that includes Locating Data and Ground Asset Data;
using deep learning to train a Neural Network (Artificial Intelligence/AI) via the Training Database Data;
using AI to generate predictions regarding the positions of utility lines and utility line characteristics; and
outputting predictions regarding the positions of utility lines and utility line characteristics.

30-50. (canceled)
